(19) United States
(12) Patent Application Publication
(10) Pub. No.: US 2024/0285375 A1
(43) Pub. Date: Aug. 29, 2024

(54) ATTACHMENT FOR INVISIBLE ORTHODONTIC APPLIANCE WITHOUT BRACKET, ORTHOPEDIC DEVICE COMBINATION, CONSTRUCTION METHOD AND SYSTEM OF ATTACHMENT

(71) Applicant: WUXI EA MEDICAL INSTRUMENTS TECHNOLOGIES LIMITED, Wuxi, Jiangsu (CN)

(72) Inventors: Yikan ZHENG, Wuxi (CN); Junxiang HOU, Wuxi (CN)

(73) Assignee: WUXI EA MEDICAL INSTRUMENTS TECHNOLOGIES LIMITED, Wuxi, Jiangsu (CN)

(21) Appl. No.: 18/573,767

(22) PCT Filed: Jun. 22, 2022
(86) PCT No.: PCT/CN2022/100465

§ 371 Date: Dec. 22, 2023

(30) Foreign Application Priority Data
Jun. 24, 2021 (CN) 202110705580.4
Jun. 24, 2021 (CN) 202121421775.8

(51) Int. Cl. A61C 7/08

(52) U.S. Cl. CPC A61C 7/08

(57) ABSTRACT

This application discloses an attachment for invisible orthodontic appliance without bracket, an orthodontic device combination, and a construction method and system. In an implementation, an attachment includes a bottom surface for attaching to a tooth, a retention surface extending upward from a partial edge of the bottom surface, and a non-retention surface connecting an upper edge of the retention surface to the remaining edge of the bottom surface; the retention surface and the bottom surface are arranged at an angle ranging from 60° to 120°, the upper edge of the retention surface defines a maximum height of the attachment in a normal direction of the bottom surface, and the retention surface includes a first retention area, a second retention area, and a third retention area sequentially connected along the partial edge of the bottom surface; the second retention area is arc-shaped on a cross-section perpendicular to a normal of the bottom surface; and an angle between the first retention area and the third retention area ranges from 60° to 120°. In another implementation, a construction method for a retention attachment is further included.

This application claims priority to Chinese Patent Application No. 202121421775.8, filed on Jun. 24, 2021 and entitled “ATTACHMENT FOR INVISIBLE ORTHODONTIC APPLIANCE WITHOUT BRACKET AND ORTHODONTIC DEVICE COMBINATION WITH THE ATTACHMENT”, and Chinese Patent Application No. 202110705580.4, filed on Jun. 24, 2021 and entitled “CONSTRUCTION METHOD AND SYSTEM FOR RETENTION ATTACHMENT, AND INVISIBLE ORTHODONTIC APPLIANCE”, which are incorporated herein by reference in their entireties.

### TECHNICAL FIELD

This application relates to an attachment, particularly an attachment for invisible orthodontic appliance without bracket, further relates to an orthodontic device combination with the attachment, a construction method and construction system for a retention attachment, and a computer-readable storage medium, and belongs to the field of orthodontic technologies.

### BACKGROUND

Invisible orthodontic technologies are becoming more and more popular because invisible orthodontic appliances have advantages such as being easy in removal and wearing, being comfort and beautiful, being easy in clinical use, and being favorable to oral hygiene cleaning. With the widespread use of invisible orthodontic appliances, some shortcomings are gradually exposed in the face of many patients with different oral conditions.

The retention of the invisible orthodontic appliance, in addition to relying on the friction between the orthodontic appliance and the teeth, mainly depends on the attachments bonded to the teeth. However, it is found during massive use of the invisible orthodontic appliance that, some patients have short dental crowns, especially for younger patients. The existing attachments cannot produce sufficient retention force for the invisible orthodontic appliance, causing the invisible orthodontic appliance to fall off accidentally during wearing.

In addition, for an attachment bonded to a labial-buccal side of a tooth, due to the inadvertent tongue licking and pressing of the patient, its retention effect on the invisible orthodontic appliance is further reduced. As a result, the invisible orthodontic appliance falls off continuously during wearing, making it impossible to continue orthodontic treatment.

### SUMMARY

An objective of this application is provide an attachment for invisible orthodontic appliance without bracket, an orthodontic device combination, and a construction method and system, to increase a retention force for an invisible orthodontic appliance, and resolve the problem in the existing technology that an orthodontic appliance is prone to fall off because an attachment has an insufficient retention force for the orthodontic appliance.

To achieve the foregoing objective, an implementation provides an attachment for invisible orthodontic appliance without bracket. The attachment includes a bottom surface for attaching to a tooth, a retention surface extending upward from a partial edge of the bottom surface, and a non-retention surface connecting an upper edge of the retention surface to the remaining edge of the bottom surface, the retention surface and the bottom surface are arranged at an angle ranging from 60° to 120°, the upper edge of the retention surface defines a maximum height of the attachment in a normal direction of the bottom surface, and the retention surface includes a first retention area, a second retention area, and a third retention area sequentially connected along the partial edge of the bottom surface; the second retention area is arc-shaped on a cross-section perpendicular to a normal of the bottom surface; and an angle between the first retention area and the third retention area ranges from 60° to 120°.

Preferably, an upper edge of the second retention area defines the maximum height of the attachment in the normal direction of the bottom surface.

Preferably, the non-retention surface is set as a convex curved surface, and an angle between a tangent plane in any position on the non-retention surface and the bottom surface is smaller than an angle between the retention surface and the bottom surface.

Preferably, on the cross-section perpendicular to the normal of the bottom surface, the second retention area is in a shape of a circular arc or in a shape of an elliptic arc with a convex middle portion.

Preferably, the retention surface and the bottom surface are arranged at an angle ranging from 60° to 90°.

Preferably, the retention surface and the bottom surface are arranged at an angle ranging from 75° to 90°.

Preferably, on the cross-section perpendicular to the normal of the bottom surface, each of the first retention area and the third retention area is any one of a straight line, a concave curved line, or a convex curved line.

Preferably, the first retention area and the third retention area are set as planes.

Preferably, each of the first retention area, the second retention area, and the third retention area is set as: a part in a straight-line curved surface having a straight line perpendicular to the bottom surface as a generatrix, having an edge of the bottom surface as a guiding line, and having each profile line perpendicular to the bottom surface; or
is set as: a part in a straight-line curved surface having a straight line at an acute angle greater than or equal to 60° with the bottom surface as a generatrix and having an edge of the bottom surface as a guiding line.

Preferably, each of the first retention area, the second retention area, and the third retention area is set as: being perpendicular to the bottom surface and extending upward along a straight line; or
is set as: being at an acute angle greater than or equal to 60° with the bottom surface and extending upward along a straight line; or
is set as: extending upward in a convex or concave curved shape, and a plane constructed by a higher endpoint of an upper edge of each retention area and two endpoints on edges of the bottom surface defines an angle between each retention area and the bottom surface.

Preferably, on the partial edge of the bottom surface, an angle between a connection line between two farthest endpoints of the first retention area and a connection line between two farthest endpoints of the third retention area defines an angle between the first retention area and the third retention area.

Preferably, the attachment further including a skid-proof structure added to the retention surface, wherein the skid-proof structure is any one of or a combination of a plurality of bumps, a plurality of dents, and one or more nicks.

To achieve the foregoing objective, an implementation provides an attachment for invisible orthodontic appliance without bracket, including a bottom surface for attaching to a tooth, a retention surface extending upward from a partial edge of the bottom surface, and a non-retention surface extending obliquely downward from an upper edge of the retention surface to the remaining edge of the bottom surface, the non-retention surface is set as a convex curved surface, an angle between a tangent plane in any position on the non-retention surface and the bottom surface is smaller than an angle between the retention surface and the bottom surface, and the retention surface includes a first retention area, a second retention area, and a third retention area sequentially connected along the partial edge of the bottom surface; the second retention area is arc-shaped on a cross-section perpendicular to a normal of the bottom surface; and an angle between the first retention area and the third retention area ranges from 60° to 120°.

To achieve the foregoing objective, an implementation provides an invisible orthodontic device combination, including:
an attachment, including a bottom surface for attaching to a tooth, a retention surface extending upward from a partial edge of the bottom surface, and a non-retention surface connecting an upper edge of the retention surface to the remaining edge of the bottom surface, the retention surface and the bottom surface are arranged at an angle ranging from 60° to 120°, the upper edge of the retention surface defines a maximum height of the attachment in a normal direction of the bottom surface, and the retention surface includes a first retention area, a second retention area, and a third retention area sequentially connected along the partial edge of the bottom surface; the second retention area is arc-shaped on a cross-section perpendicular to a normal of the bottom surface; and an angle between the first retention area and the third retention area ranges from 60° to 120°;
a shell-shaped orthodontic appliance, defining an inner cavity capable of accommodating a dentition and including an accommodating groove in communication with the inner cavity and capable of accommodating the attachment, and the retention surface butts against a groove surface of the accommodating groove to prevent the orthodontic appliance from separating from the dentition.

Preferably, an upper edge of the second retention area defines the maximum height of the attachment in the normal direction of the bottom surface.

Preferably, the non-retention surface is set as a convex curved surface, and an angle between a tangent plane in any position on the non-retention surface and the bottom surface is smaller than an angle between the retention surface and the bottom surface.

Preferably, on the cross-section perpendicular to the normal of the bottom surface, the second retention area is in a shape of a circular arc or in a shape of an elliptic arc with a convex middle portion.

Preferably, the retention surface and the bottom surface are arranged at an angle ranging from 60° to 90°.

Preferably, the retention surface and the bottom surface are arranged at an angle ranging from 75° to 90°.

Preferably, on the cross-section perpendicular to the normal of the bottom surface, each of the first retention area and the third retention area is any one of a straight line, a concave curved line, or a convex curved line.

Preferably, the first retention area and the third retention area are set as planes.

Preferably, each of the first retention area, the second retention area, and the third retention area is set as: a part in a straight-line curved surface having a straight line perpendicular to the bottom surface as a generatrix, having an edge of the bottom surface as a guiding line, and having each profile line perpendicular to the bottom surface; or
is set as: a part in a straight-line curved surface having a straight line at an acute angle greater than or equal to 60° with the bottom surface as a generatrix and having an edge of the bottom surface as a guiding line.

Preferably, each of the first retention area, the second retention area, and the third retention area is set as: being perpendicular to the bottom surface and extending upward along a straight line; or
is set as: being at an acute angle greater than or equal to 60° with the bottom surface and extending upward along a straight line; or
is set as: extending upward in a convex or concave curved shape, and a plane constructed by a higher endpoint of an upper edge of each retention area and two endpoints on edges of the bottom surface defines an angle between each retention area and the bottom surface.

Preferably, on the partial edge of the bottom surface, an angle between a connection line between two farthest endpoints of the first retention area and a connection line between two farthest endpoints of the third retention area defines an angle between the first retention area and the third retention area.

Preferably, the attachment further including a skid-proof structure added to the retention surface, wherein the skid-proof structure is any one of or a combination of a plurality of bumps, a plurality of dents, and one or more nicks.

Preferably, the first retention area butts against a distal groove surface of the accommodating groove, and the third retention area butts against a gingival groove surface of the accommodating groove.

Preferably, the distal groove surface is at an angle ranging from 45° to 90° with a vertical surface of a long axis of a shell unit in which the accommodating groove is located in an extending direction from a gingiva end of the distal groove surface to an occlusion end of the distal groove surface; and the gingival groove surface is at an angle ranging from 0° to 30° with the vertical surface of the long axis of the shell unit in which the accommodating groove is located in an extending direction from a distal end of the gingival groove surface to a mesial end of the gingival groove surface;
and/or, the first retention area is at an angle ranging from 45° to 90° with a vertical surface of a long axis of a tooth on which the attachment is located in an extending direction from a gingiva end of the first retention area to an occlusion end of the first retention area; and the third retention area is at an angle ranging from 0° to 30° with the vertical surface of the long axis of the tooth on which the attachment is located in an extending direction from a distal end of the third retention area to a mesial end of the third retention area.

Preferably, the shell-shaped orthodontic appliance includes a labial-buccal shell and a lingual shell, and the accommodating groove is disposed in the labial-buccal shell and located in any one or more of shell units of the shell-shaped orthodontic appliance that correspond to molars and premolars.

Preferably, the accommodating groove is located in a shell unit of the shell-shaped orthodontic appliance that corresponds to a last tooth, and/or located in a shell unit of the shell-shaped orthodontic appliance that corresponds to a second-to-last tooth.

To achieve the foregoing objective, an orthodontic device combination, including:
an attachment, including a bottom surface for attaching to a tooth, a retention surface extending upward from a partial edge of the bottom surface, and a non-retention surface extending obliquely downward from an upper edge of the retention surface to the remaining edge of the bottom surface, the non-retention surface is set as a convex curved surface, an angle between a tangent plane in any position on the non-retention surface and the bottom surface is smaller than an angle between the retention surface and the bottom surface, and the retention surface includes a first retention area, a second retention area, and a third retention area sequentially connected along the partial edge of the bottom surface; the second retention area is arc-shaped on a cross-section perpendicular to a normal of the bottom surface; and an angle between the first retention area and the third retention area ranges from 60° to 120°;
a shell-shaped orthodontic appliance, defining an inner cavity capable of accommodating a dentition and including an accommodating groove in communication with the inner cavity and capable of accommodating the attachment, and the retention surface butts against a groove surface of the accommodating groove to prevent the orthodontic appliance from separating from the dentition.

To achieve the foregoing objective, an implementation provides a construction method for a retention attachment, wherein the retention attachment includes a bottom surface for attaching to a tooth, and a gingival retention surface, a corner retention surface, and a distal retention surface sequentially connected along a partial edge of the bottom surface, and the method includes the following steps:
obtaining a dentition model and a shell-shaped orthodontic appliance model matching the dentition model; and
selecting a mounting position from an attachment mounting selectable area on the dentition model, and constructing the retention attachment based on the mounting position, wherein the constructing the retention attachment based on the mounting position includes:
removing the shell-shaped orthodontic appliance model worn on the dentition model from the dentition model, and obtaining a moving track of a reference position on the shell-shaped orthodontic appliance model that corresponds to the mounting position; and
establishing a tangent line of a key position or a direct connection line between two key positions in the moving track, and constructing the retention attachment satisfying the following rules:
a rule 1: the bottom surface fits the attachment mounting selectable area; and
a rule 2: an intersection line of the gingival retention surface and the bottom surface is a first straight line, an intersection line of the gingival retention surface and the corner retention surface includes a highest point in a normal direction of the bottom surface, and a plane defined by the first straight line and the highest point is at an angle ranging from 60° to 90° with the tangent line or the direct connection line; or an intersection line of the gingival retention surface and the corner retention surface is a second straight line, an intersection line of the gingival retention surface and the bottom surface includes a farthest point away from the corner retention surface, and a plane defined by the second straight line and the farthest point is at an angle ranging from 60° to 90° with the tangent line or the direct connection line.

Preferably, the step of “selecting a mounting position from an attachment mounting selectable area on the dentition model, and constructing the retention attachment based on the mounting position” further includes:
using the tangent line or the direct connection line in the step of “establishing a tangent line of a key position or a direct connection line between two key positions in the moving track” as a first auxiliary line, and further establishing a second auxiliary line different from the first auxiliary line, wherein the second auxiliary line is a tangent line of a key position or a direct connection line between two key positions in the moving track; and
the retention attachment further satisfies a rule 4: a plane defined by two endpoints of an intersection line of the corner retention surface and the bottom surface and the highest point is at an angle ranging from 60° to 90° with the second auxiliary line.

Preferably, the corner retention surface is convex-arc-shaped on a cross-section perpendicular to the normal direction of the bottom surface.

Preferably, the key position is selected from a start position, an end position that is defined by an intersection point of a boundary of a normal projection space of the attachment mounting selectable area and the moving track, and transitional positions located between the start position and the end position.

Preferably, the first auxiliary line is set as a tangent line of the start position, and the second auxiliary line is set as a direct connection line between the start position and the end position.

Preferably, any one of the gingival retention surface, the corner retention surface, and the distal retention surface is set as: extending away from the bottom surface along a straight line at an angle ranging from 60° to 120° with the bottom surface.

Preferably, each of the gingival retention surface and the distal retention surface is set as a plane or a curved surface, and the corner retention surface is set as a cylindrical arc surface.

Preferably, the intersection line of the gingival retention surface and the bottom surface includes the farthest point away from the corner retention surface and a closest point intersecting with the corner retention surface;
an intersection line of the distal retention surface and the bottom surface includes an extremely far point away from the corner retention surface and an extremely close point intersecting with the corner retention surface; and
the step of “establishing a tangent line of a key position or a direct connection line between two key positions in the moving track, and constructing the retention attachment satisfying the following rules” further includes a rule 3: on a projection surface in the normal direction of the bottom surface, a direct connection line from the closest point to the farthest point is at an angle ranging from 60° to 120° with a direct connection line from the extremely close point to the extremely far point.

Preferably, the gingival retention surface is set as: extending away from the bottom surface in a concave curved shape from the intersection line of the gingival retention surface and the bottom surface, and a plane defined by two endpoints of the intersection line of the gingival retention surface and the bottom surface and the highest point is an angle ranging from 60° to 120° with the bottom surface;
and/or the corner retention surface is set as: extending away from the bottom surface in a concave curved shape from the intersection line of the corner retention surface and the bottom surface, and a plane defined by the extremely close point, the closest point, and the highest point is an angle ranging from 60° to 120° with the bottom surface;
and/or the distal retention surface is set as: extending away from the bottom surface in a concave curved shape from the intersection line of the distal retention surface and the bottom surface, and a plane defined by two endpoints of the intersection line of the distal retention surface and the bottom surface and a highest endpoint of an intersection line of the distal retention surface and the corner retention surface in the normal direction of the bottom surface is an angle ranging from 60° to 120° with the bottom surface.

Preferably, on the projection surface in the normal direction of the bottom surface, a direct connection line between the farthest point and the closest point is at an angle ranging from 60° to 90° with a long axis of a tooth on which the attachment mounting selectable area is located;
and/or on the projection surface in the normal direction of the bottom surface, a direct connection line between the extremely far point and the extremely close point is at an angle ranging from 0° to 45° with the long axis of the tooth on which the attachment mounting selectable area is located.

Preferably, an upper edge of any one of the gingival retention surface, the corner retention surface, and the distal retention surface defines a maximum height of the retention attachment in the normal direction of the bottom surface.

Preferably, in the step of “obtaining a moving track of a reference position on the shell-shaped orthodontic appliance model that corresponds to the mounting position”, N coordinates of the reference position under a space coordinate system are sequentially recorded, the N coordinates are fit into one curved line in sequence, and the curved line forms the moving track, wherein N≥2, and the N coordinates include a start coordinate of the reference position corresponding to a case that the shell-shaped orthodontic appliance model is worn on the dentition model.

Preferably, the attachment mounting selectable area is located on a labial-buccal surface of the dentition model; and
in the step of “removing the shell-shaped orthodontic appliance model worn on the dentition model from the dentition model”, a lingual side of the shell-shaped orthodontic appliance model is used as an acting area of an actuating force, and the shell-shaped orthodontic appliance model worn on the dentition model is removed from the dentition model with the actuating force,
wherein the actuating force points to an occlusion end along a long axis; or the actuating force includes a component pointing to an occlusion end along a long axis and a component pointing to the labial-buccal surface perpendicular to the long axis.

Preferably, in the step of “removing the shell-shaped orthodontic appliance model worn on the dentition model from the dentition model”, a lingual gingiva edge midpoint of a last molar shell unit of the shell-shaped orthodontic appliance model is used as the acting area of the actuating force.

Preferably, the attachment mounting selectable area includes two or more to-be-selected mounting positions, and in the construction method, all the mounting positions are traversed, to sequentially perform the following on each mounting position: the step of “selecting a mounting position from an attachment mounting selectable area on the dentition model, and constructing the retention attachment based on the mounting position”; and evaluating a retention force of the constructed retention attachment; and
the construction method further includes a step of: determining a final retention attachment and a mounting position corresponding to the final retention attachment among all constructed retention attachments according to a priority selection principle in which the retention force is maximum.

Preferably, a plurality of nodes distributed in a row-column matrix are planned in the attachment mounting selectable area, and all or part of the nodes are used as the to-be-selected mounting positions.

Preferably, the “two or more to-be-selected mounting positions” include two or more of an internal center point, a mesial edge center point, a mesial edge occlusion endpoint, a mesial edge gingiva endpoint, a distal edge center point, a distal edge occlusion endpoint, a distal edge gingiva endpoint, an occlusion edge center point, and a gingiva edge center point of the attachment mounting selectable area.

Preferably, the step of “evaluating a retention force of the constructed retention attachment” includes:
adding the constructed retention attachment to the dentition model to serve as a second dentition model, and obtaining a second shell-shaped orthodontic appliance model matching the second dentition model; and
obtaining an actuating force of removing the second shell-shaped orthodontic appliance model worn on the second dentition model from the second dentition model, and using the actuating force as the retention force of the retention attachment.

To achieve the foregoing objective, an implementation provides a construction system for a retention attachment, including a memory and a processor, the memory stores a computer program runnable on the processor, and when the processor executes the computer program, the steps of the construction method for a retention attachment are implemented.

To achieve the foregoing objective, an implementation provides a computer-readable storage medium, storing a computer program, when the computer program is executed by a processor, the steps of the construction method for a retention attachment are implemented.

To achieve the foregoing objective, an implementation provides an invisible orthodontic appliance, including:
a shell-shaped orthodontic appliance, defining an inner cavity capable of accommodating a dentition and including an attachment accommodating groove in communication with the inner cavity; and
a retention attachment, wherein the retention attachment is constructed with the construction method for a retention attachment, and includes a bottom surface for attaching to a tooth on a dentition, and each of the gingival retention surface, the corner retention surface, and the distal retention surface butts against a groove surface of the attachment accommodating groove to prevent the orthodontic appliance from separating from the dentition.

Preferably, the orthodontic appliance includes a labial-buccal shell and a lingual shell, and the attachment accommodating groove is disposed in the labial-buccal shell and located in any one or more of shell units of the orthodontic appliance that correspond to molars and premolars.

Preferably, the attachment accommodating groove is located in a shell unit of the orthodontic appliance that corresponds to a last molar, and/or located in a shell unit of the orthodontic appliance that corresponds to a second-to-last tooth.

Compared with the prior art, this application has the following beneficial effects: the retention surface and the bottom surface are arranged at an angle ranging from 60° to 90°, the first retention area and the third retention area are arranged at an angle ranging from 60° to 120° and connected through the arc-shaped second retention area, and the upper edge of the second retention area defines the maximum height of the attachment, to integrally construct the wedge-shaped retention surface and enhance the retention effect on the orthodontic appliance, so that the pressure between the orthodontic appliance and the attachment may be higher after being pressed more tightly against each other in an accidental fall-off movement, to ensure a sufficient retention effect on the orthodontic appliance and provide a more obvious retention advantage compared with the existing attachment particularly for a patient with a short dental crown, for example, a young patient. In addition, through design and optimization of the retention attachment, the retention force of the retention attachment for the orthodontic appliance can be increased, to resolve the problem in the existing technology that an orthodontic appliance is prone to fall off because a retention attachment has an insufficient retention force for the orthodontic appliance.

### BRIEF DESCRIPTION OF THE DRAWINGS

FIG. 1a is a schematic three-dimensional structural diagram of an attachment according to Embodiment 1 of this application;

FIG. 1b is a schematic diagram of a projection of an attachment in a normal direction of a bottom surface of the attachment according to Embodiment 1 of this application;

FIG. 1c is a schematic diagram of a cross-section along a cutting line A-A in FIG. 1a, wherein the shown cross-section is parallel to a normal of a bottom surface of an attachment and passes through a highest point of the attachment in a normal direction of the bottom surface;

FIG. 2a is a schematic three-dimensional structural diagram of an orthodontic device combination formed by an attachment and an orthodontic appliance according to Embodiment 1 of this application, wherein a state in which the attachment attaches to a tooth is shown;

FIG. 2b is a structural view of a shell unit provided with an accommodating groove on a labial-buccal side according to Embodiment 1 of this application;

FIG. 2c is a structural view of a tooth equipped with an attachment on a labial-buccal surface according to Embodiment 1 of this application;

FIG. 3a is a schematic three-dimensional structural diagram of an attachment according to Embodiment 2 of this application;

FIG. 3b is a schematic diagram of a projection of an attachment in a normal direction of a bottom surface of the attachment according to Embodiment 2 of this application;

FIG. 3c is a schematic diagram of a cross-section along a cutting line A-A in FIG. 3a, wherein the shown cross-section is parallel to a normal of a bottom surface of an attachment and passes through a highest point of the attachment in a normal direction of the bottom surface;

FIG. 4a is a schematic three-dimensional structural diagram of an attachment according to Embodiment 3 of this application;

FIG. 4b is a schematic diagram of a projection of an attachment in a normal direction of a bottom surface of the attachment according to Embodiment 3 of this application;

FIG. 5a is a schematic three-dimensional structural diagram of an attachment according to Embodiment 4 of this application;

FIG. 5b is a schematic diagram of a projection of an attachment in a normal direction of a bottom surface of the attachment according to Embodiment 4 of this application;

FIG. 6a is a schematic three-dimensional structural diagram of an attachment according to Embodiment 5 of this application;

FIG. 6b is a schematic diagram of a projection of an attachment in a normal direction of a bottom surface of the attachment according to Embodiment 5 of this application;

FIG. 7a is a schematic three-dimensional structural diagram of an attachment according to Embodiment 6 of this application;

FIG. 7b is a schematic diagram of a projection of an attachment in a normal direction of a bottom surface of the attachment according to Embodiment 6 of this application;

FIG. 8a is a schematic three-dimensional structural diagram of an attachment according to Embodiment 7 of this application;

FIG. 8b is a schematic diagram of a projection of an attachment in a normal direction of a bottom surface of the attachment according to Embodiment 7 of this application;

FIG. 9a is a schematic three-dimensional structural diagram of an attachment according to Embodiment 8 of this application;

FIG. 9b is a schematic diagram of a projection of an attachment in a normal direction of a bottom surface of the attachment according to Embodiment 8 of this application;

FIG. 10a is a schematic three-dimensional structural diagram of an attachment according to Embodiment 9 of this application;

FIG. 10b is a schematic diagram of a projection of an attachment in a normal direction of a bottom surface of the attachment according to Embodiment 9 of this application;

FIG. 11a is a schematic three-dimensional structural diagram of an attachment according to Embodiment 10 of this application;

FIG. 11b is a schematic diagram of a projection of an attachment in a normal direction of a bottom surface of the attachment according to Embodiment 10 of this application;

FIG. 12 is a flowchart of a construction method for a retention attachment according to Embodiment 11 of this application;

FIG. 13 is a schematic diagram of a dentition model and a shell-shaped orthodontic appliance model according to Embodiment 11 of this application;

FIG. 14 is a schematic diagram of a shell-shaped orthodontic appliance model worn on a dentition model according to Embodiment 11 of this application;

FIG. 15 is a schematic diagram of a shell-shaped orthodontic appliance model removed from a dentition model according to Embodiment 11 of this application;

FIG. 16 is a schematic diagram of a moving track of a reference position in a space coordinate system according to Embodiment 11 of this application;

FIG. 17 is a schematic structural diagram of an invisible orthodontic appliance according to Embodiment 11 of this application, wherein a state in which a retention attachment is mounted on a tooth is shown;

FIG. 18a to FIG. 18c are schematic diagrams of a retention attachment according to Embodiment 11 of this application, wherein FIG. 18a is a schematic three-dimensional structural diagram of the retention attachment, FIG. 18b is a schematic diagram of a projection of the retention attachment in a normal direction of a bottom surface of the retention attachment, FIG. 18c is a schematic diagram of a cross-section along a cutting line A-A in FIG. 18a, and the shown cross-section is parallel to a normal of the bottom surface and passes through a highest point of the retention attachment in the normal direction of the bottom surface;

FIG. 18d and FIG. 18e are schematic diagrams of a projection of a retention attachment in a normal direction of a bottom surface of the retention attachment according to simple changed examples of Embodiment 11 of this application;

FIG. 19a is a structural view of a tooth equipped with a retention attachment according to Embodiment 11 of this application on a labial-buccal surface;

FIG. 19b is a structural view of a shell unit provided with an accommodating groove on a labial-buccal side according to Embodiment 11 of this application;

FIG. 20a to FIG. 20c are schematic diagrams of a retention attachment according to Embodiment 12 of this application, wherein FIG. 20a is a schematic three-dimensional structural diagram of the retention attachment, FIG. 20b is a schematic diagram of a projection of the retention attachment in a normal direction of a bottom surface of the retention attachment, FIG. 20c is a schematic diagram of a cross-section along a cutting line A-A in FIG. 20a, and the shown cross-section is parallel to a normal of the bottom surface and passes through a highest point of the retention attachment in the normal direction of the bottom surface;

FIG. 21a and FIG. 21b are schematic diagrams of a retention attachment according to Embodiment 13 of this application, wherein FIG. 21a is a schematic three-dimensional structural diagram of the retention attachment, and FIG. 21b is a schematic diagram of a projection of the retention attachment in a normal direction of a bottom surface of the retention attachment;

FIG. 22a and FIG. 22b are schematic diagrams of a retention attachment according to Embodiment 14 of this application, wherein FIG. 22a is a schematic three-dimensional structural diagram of the retention attachment, and FIG. 22b is a schematic diagram of a projection of the retention attachment in a normal direction of a bottom surface of the retention attachment;

FIG. 23a and FIG. 23b are schematic diagrams of a retention attachment according to Embodiment 15 of this application, wherein FIG. 23a is a schematic three-dimensional structural diagram of the retention attachment, and FIG. 23b is a schematic diagram of a projection of the retention attachment in a normal direction of a bottom surface of the retention attachment;

FIG. 24a and FIG. 24b are schematic diagrams of a retention attachment according to Embodiment 16 of this application, wherein FIG. 24a is a schematic three-dimensional structural diagram of the retention attachment, and FIG. 24b is a schematic diagram of a projection of the retention attachment in a normal direction of a bottom surface of the retention attachment;

FIG. 25a to FIG. 25c are schematic diagrams of a retention attachment according to Embodiment 17 of this application, wherein FIG. 25a is a schematic three-dimensional structural diagram of the retention attachment, FIG. 25b is a schematic diagram of a projection of the retention attachment in a normal direction of a bottom surface of the retention attachment, FIG. 25c is a schematic diagram of a cross-section along a cutting line A-A in FIG. 25a, and the shown cross-section is parallel to a normal of the bottom surface and passes through a highest point of the retention attachment in the normal direction of the bottom surface;

FIG. 26 is a flowchart of a construction method for a retention attachment according to Embodiment 18 of this application;

FIG. 27 is a schematic diagram of an attachment mounting selectable area according to Embodiment 18 of this application.

### DETAILED DESCRIPTION

Implementations of this application are described in detail below with reference with the specific embodiments shown in the accompanying drawings. However, these embodiments do not limit this application, and structural, methodological, or functional transformations made by a person of ordinary skill in the art according to these embodiments are included in the protection scope of this application.

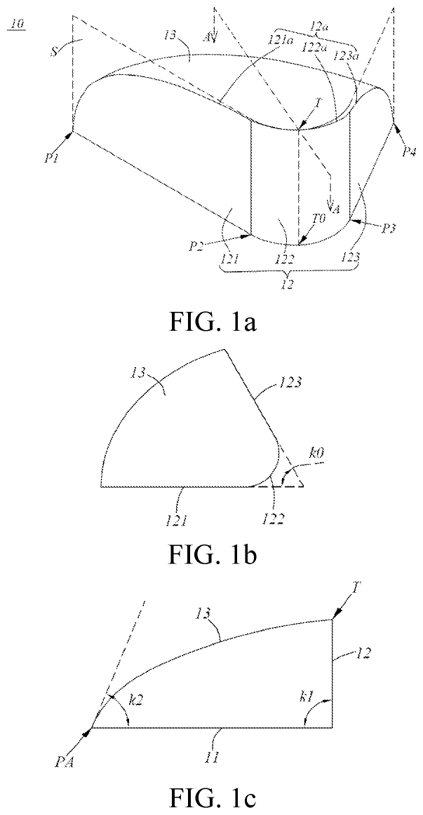

Referring to FIG. 1a to FIG. 1c, a preferred embodiment 1 of an attachment provided in this application is shown. The shown attachment 10 is applied to an invisible orthodontic technology, and is preferably applied to the invisible orthodontic technology as a retention attachment.

The attachment 10 includes a bottom surface 11, a retention surface 12, and a non-retention surface 13, and may be specifically set as a closed three-dimensional body defined by the bottom surface 11, the retention surface 12, and the non-retention surface 13.

The bottom surface 11 is used for attaching to a tooth, that is, in an invisible orthodontic process, the attachment 10 is fixedly mounted on a surface of the tooth through the bottom surface 11 of the attachment 10. Therefore, the bottom surface 11 may also be referred to as a mounting surface, an attaching surface, or the like. In a specific implementation of attaching to the tooth, the bottom surface 11 may be fixed on the surface of the tooth in a sticking manner.

The configuration of the bottom surface 11 substantially matches that of a surface of a tooth 1a on which the attachment 10 is mounted. In the accompanying drawing, the bottom surface 11 is, for example, a smooth plane. However, the configuration of the bottom surface 11 is not limited thereto. For example, in a changed embodiment, the bottom surface 11 may alternatively be a smooth concave surface, to accommodate more adhesive, thereby better fixing the attachment 10 on the tooth. For example, in another changed embodiment, the bottom surface 11 is not smooth but is additionally provided with any one of or a combination of a plurality of bumps and a plurality of dents, to increase the surface area of contact between the bottom surface 11 and the adhesive, thereby better fixing the attachment 10 on the tooth.

Referring to FIG. 1a to FIG. 1c, the retention surface 12 extends upward from a partial edge of the bottom surface 11, until reaching an upper edge 12a of the retention surface 12, that is, gradually moves away from the bottom surface 11 and is at a distance from the bottom surface 11 gradually increasing in a normal direction of the bottom surface 11.

About the “partial edge of the bottom surface 11”, as shown in FIG. Ta, a peripheral edge of the bottom surface 11 includes points P1, P2, P3, and P4 sequentially arranged, and the “partial edge of the bottom surface 11” is the part from the point P1, the point P2 and the point P3, to the point P4 of the peripheral edge of the bottom surface 11, and is denoted as an “edge P1-P2-P3-P4” below for ease of understanding and description.

In addition, the upper edge 12a of the retention surface 12 defines a maximum height of the attachment 10 in the normal direction of the bottom surface 11. As shown in FIG. 1a, a point T in the upper edge 12a is, for example, a highest point of the attachment 10 in the normal direction of the bottom surface 11.

In this application, the retention surface 12 and the bottom surface 11 are arranged at an angle ranging from 60° to 120°, may be preferably arranged at an angle ranging from 60° to 90°, and be further preferably arranged at an angle ranging from 75° to 90°, to provide an acting force to the orthodontic appliance and implement retention of the orthodontic appliance on the dentition.

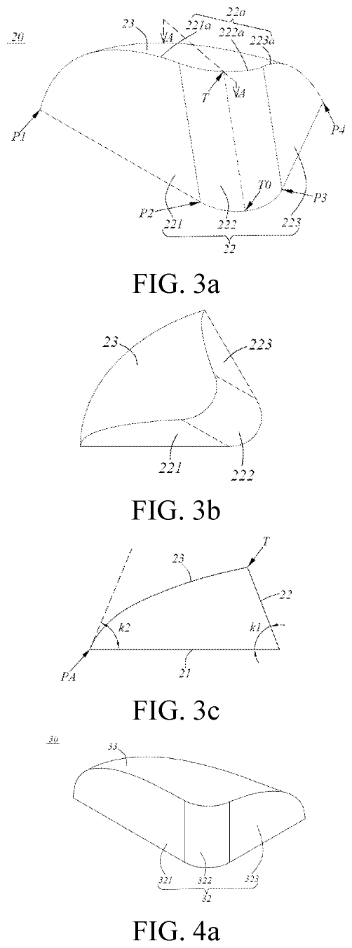

Specifically, in this embodiment, as shown in FIG. 1c, an angle k1 between the retention surface 12 and the bottom surface 11 is 90°, that is, the retention surface 12 is perpendicular to the bottom surface 11 and parallel to the normal of the bottom surface 11. Certainly, the value of the angle k1 is not limited thereto, and is, for example, shown below in FIG. 3a to FIG. 3c.

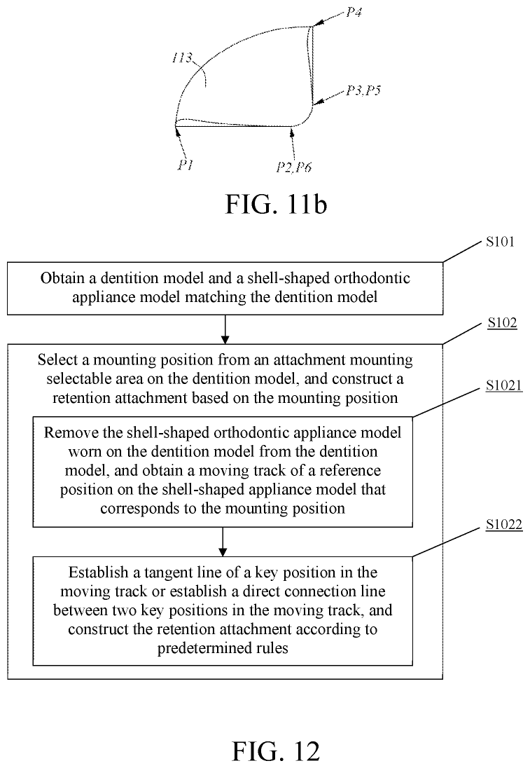

In addition, in this embodiment, the retention surface 12 extends upward along a straight line perpendicular to the bottom surface 11. In other words, the retention surface 12 is set as a straight-line curved surface whose profile lines are all perpendicular to the bottom surface 11. As shown in FIG. Ta, the straight-line curved surface is a part of a surface S, and the surface S is constructed with a straight line T-T0 perpendicular to the bottom surface 11 (that is, a line segment in the retention surface 12 that passes through the highest point T) used as a generatrix and with the partial edge of the bottom surface 11 (that is, an edge P1-P2-P3-P4) used as a guiding line. Certainly, the retention surface 12 is not limited to necessarily extending upward along a straight line perpendicular to the bottom surface 11, and is, for example, shown below in FIG. 10a and FIG. 10b, and FIG. 11a and FIG. 11b.

In this application, the retention surface 12 includes a first retention area 121, a second retention area 122, and a third retention area 123 sequentially connected along the partial edge of the bottom surface 11 (that is, the edge P1-P2-P3-P4). An angle relationship between the retention surface 12 and the bottom surface 11 is jointly determined by respective angle relationships between the first retention area 121, the second retention area 122, and the third retention area 123 and the bottom surface 11. Specifically, the retention surface 12 and the bottom surface 11 are arranged at an angle ranging from 60° to 120°, that is, each of the first retention area 121, the second retention area 122, and the third retention area 123 and the bottom surface 11 are arranged at an angle ranging from 60° to 120°. Certainly, respective angles between the first retention area 121, the second retention area 122, and the third retention area 123 and the bottom surface 11 may be the same or different.

The first retention area 121 extends upward along a straight line from an edge P1-P2 of the bottom surface 11, until reaching an upper edge 121a thereof. It may be understood that, the upper edge 121a is a part of the upper edge 12a of the retention surface 12.

The third retention area 123 extends upward along a straight line from an edge P3-P4 of the bottom surface 11, until reaching an upper edge 123a thereof. It may be understood that, the upper edge 123a is also a part of the upper edge 12a of the retention surface 12.

In this application, an angle k0 between the first retention area 121 and the third retention area 123 ranges from 60° to 120°. Therefore, through the wedge-shaped structure, the retention effect on the orthodontic appliance is enhanced, so that the pressure between the orthodontic appliance and the attachment 10 may be higher after being pressed more tightly against each other in an accidental fall-off movement. The angle k0 ranges from 60° to 90° more preferably. As shown in FIG. Tb, in this embodiment, the angle k0 is an acute angle greater than or equal to 60°.

More specifically, in this embodiment, the first retention area 121 is a straight line on the cross-section perpendicular to the normal of the bottom surface 11. Given that the first retention area 121 extends upward in a straight line perpendicular to the bottom surface 11, the first retention area 121 is a plane in this embodiment.

Similarly, as shown in FIG. Tb, the third retention area 123 is a straight line on the cross-section perpendicular to the normal of the bottom surface 11. Given that the third retention area 123 extends upward in a straight line perpendicular to the bottom surface 11, the third retention area 123 is also a plane in this embodiment.

The second retention area 122 intersects with each of the first retention area 121 and the third retention area 123, that is, the first retention area 121 and the third retention area 123 are connected to each other through the second retention area 122. The second retention area 122 extends upward along a straight line from an edge P2-P3 of the bottom surface 11, until reaching an upper edge 122a thereof. The upper edge 122a is a part of the upper edge 12a of the retention surface 12, and defines a maximum height of the attachment 10 in the normal direction of the bottom surface 11, that is, the highest point T is located in the upper edge 122a. Certainly, the highest point T may alternatively be located in the upper edge 121a or the upper edge 123a during changed implementation.

In this application, on the cross-section perpendicular to the normal of the bottom surface 11, the second retention area 122 is in a shape of an arc, and may be specifically in a shape of a circular arc, in a shape of an elliptic arc, or in a shape of another type of arc with a convex middle portion. For example, in this embodiment of the accompanying drawing, the second retention area 122 is in a shape of a circular arc with a radius 0.5 mm on the cross-section perpendicular to the normal of the bottom surface 11. It may be understood that, given that the retention surface 12 extends upward in a straight line perpendicular to the bottom surface 11, the second retention area 122 is a cylindrical arc surface with a radius 0.5 mm in this embodiment.

It should be noted herein that respective configurations of the first retention area 121, the second retention area 122, and the third retention area 123 are not limited to those in this embodiment. For example, each of the three configurations is individually changed and implemented into a configuration shown in subsequent embodiments 2 to 10.

In addition, further, the attachment 10 may further include a skid-proof structure added to the retention surface 12, wherein the skid-proof structure may be specifically any one of or a combination of a plurality of bumps, a plurality of dents, and one or more nicks, to enhance a friction force between the attachment 10 and the orthodontic appliance and ensure the retention effect on the orthodontic appliance.

Referring to FIG. 1a to FIG. 1c, the non-retention surface 13 connects the upper edge 12a of the retention surface 12 to the remaining edge of the bottom surface 11.

The “remaining edge of the bottom surface 11” corresponds to the foregoing “partial edge of the bottom surface 11”, that is, apart remaining after the edge P1-P2-P3-P4 is excluded from the peripheral edge of the bottom surface 11, that is, an edge part not shown in FIG. 1a between the point P1 and the point P4.

In contrast to the retention surface 12, the non-retention surface 13 has no retention effect on the orthodontic appliance on the dentition, and has a more gentle relationship with the bottom surface 11 compared with the relationship between the retention surface 12 and the bottom surface 11, and the configuration of the non-retention surface 13 helps guide the orthodontic appliance to be in place smoothly, for example, guide an accommodating groove 101 of the orthodontic appliance to be smoothly stuck at the attachment 10 in the following description. Therefore, the non-retention surface 13 may also be referred to as a guiding surface.

Specifically, the non-retention surface 13 extends obliquely downward from the upper edge 12a of the retention surface 12 until intersecting with the remaining edge of the bottom surface 11, that is, gradually approaches the bottom surface 11 and is at a distance from the bottom surface 11 gradually decreasing in a normal direction of the bottom surface 11. Therefore, the non-retention surface 13 has a downward trend integrally starting from the upper edge 12a of the retention surface 12, to help the non-retention surface 13 guide the orthodontic appliance to be in place smoothly.

More preferably, in this embodiment, the non-retention surface 13 is set as a convex curved surface, and an angle k2 between a tangent plane in any position on the non-retention surface 13 and the bottom surface 11 is smaller than the angle k1 between the retention surface 12 and the bottom surface 11, for example, smaller than 60°. On the cross-section shown in FIG. 1c, at an intersection point PA of the non-retention surface 13 and the bottom surface 11, the angle k2 has a maximum value and is smaller than 60°. From the intersection point PA to the highest point T, the angle k2 gradually decreases, that is, the non-retention surface 13 is more gentle at a larger height.

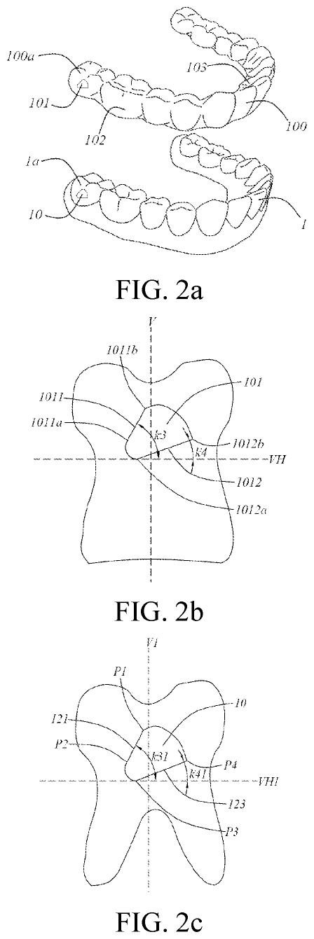

Next, referring to FIG. 2a, an application of the attachment 10 in the embodiment 1 is provided. A combination formed by the attachment 10 and an orthodontic appliance 100 is specifically shown in the drawing, and the attachment 10 attaches onto a dentition 1 and provides a retention force for the orthodontic appliance 100 adapting to the dentition 1.

The orthodontic appliance 100 is a shell-shaped orthodontic appliance whose inner cavity may accommodate the dentition 1. It may be understood that, the orthodontic appliance 100 includes shell units adapting to structural styles of teeth one by one. For example, corresponding to a tooth 1a, the orthodontic appliance 100 includes a shell unit 100a, and an inner cavity of the shell unit 100a may just accommodate the tooth 1a.

The orthodontic appliance 100 further includes an accommodating groove 101, and the accommodating groove 101 is in communication with the inner cavity of the orthodontic appliance 100 and may accommodate the attachment 10. When the orthodontic appliance 100 is mounted onto the dentition 1, the non-retention surface 13 of the attachment 10 helps guide the orthodontic appliance 100 to be in place smoothly, so that the accommodating groove 101 of the orthodontic appliance 100 is smoothly stuck at the attachment 10, that is, the attachment 10 is embedded in the accommodating groove 101. When the orthodontic appliance 100 is maintained on the dentition 1, that is, is in a mounting completed state, the retention surface 12 of the attachment 10 may butt against a groove surface of the accommodating groove 101, to prevent the orthodontic appliance 100 from separating from the dentition 1, and enhance the retention effect on the orthodontic appliance 100.

Preferably, the third retention area 123 of the retention surface 12 butts against a gingival groove surface of the accommodating groove 101, the gingival groove surface is a groove surface of the accommodating groove 101 close to the gingival side. Therefore, by butting against the gingival groove surface of the accommodating groove 101, the retention force applied by the third retention area 123 mainly to the orthodontic appliance 100 includes a large component pointing to the gingival side, to prevent the orthodontic appliance 100 from lifting from the dentition 1 away from the gingival side.

Correspondingly, the first retention area 121 of the retention surface 12 butts against a distal groove surface of the accommodating groove 101, the distal groove surface is a groove surface of the accommodating groove 101 close to the distal side. Therefore, by butting against the distal groove surface of the accommodating groove 101, the retention force applied by the first retention area 121 mainly to the orthodontic appliance 100 includes a large component pointing to the distal side, to prevent the orthodontic appliance 100 from lifting toward the front of the dentition 1.

Therefore, through the integral effect of the first retention area 121 and the third retention area 123, the retention effect on the orthodontic appliance 100 is enhanced, to prevent the orthodontic appliance 100 from falling off.

Further, preferably, the orthodontic appliance 100 includes a labial-buccal shell 102 and a lingual shell 103. When the orthodontic appliance 100 is mounted onto the dentition 1, the labial-buccal shell 102 is located on a labial-buccal side of the dentition 1, and the lingual shell 103 is located on a lingual side of the dentition 1.

Accommodating grooves 101 are disposed in the labial-buccal shell 102 and located in any one or more of a plurality of shell units on the orthodontic appliance 100 that correspond to molars and premolars. For example, the orthodontic appliance 100 shown in FIG. 2a includes a shell unit corresponding to a first molar (for ease of understanding, subsequently referred to as a “first molar shell unit”), a shell unit 100a corresponding to a second molar 1a (for ease of understanding, subsequently referred to as a “second molar shell unit 100a”), a shell unit corresponding to a first premolar (for ease of understanding, subsequently referred to as a “first premolar shell unit”), and a shell unit corresponding to a second premolar (for ease of understanding, subsequently referred to as a “second premolar shell unit”). Any one of or any two or more of the first molar shell unit, the second molar shell unit 100a, the first premolar shell unit, and the second premolar shell unit are provided with accommodating grooves 101. It may be understood that, corresponding teeth are also equipped with attachments 10 matching the accommodating grooves 101. Certainly, in a changed implementation, for a dentition including a third molar, the appliance 100 correspondingly includes a third molar shell unit corresponding to the third molar, and an accommodating groove 101 may also be located in the third molar shell unit.

Preferably, as shown in FIG. 2a, the accommodating groove 101 is located in a shell unit of the orthodontic appliance 100 (such as the second molar shell unit 100a in FIG. 2a), which corresponds to a last tooth (such as the second molar 1a in FIG. 2a). That is to say, referring to FIG. 2a, the accommodating groove 101 is disposed on a labial-buccal side of the shell unit 100a. It can be understood that corresponding to the position of the accommodating groove 101, the attachment 10 is similarly mounted on a labial-buccal side of the last tooth (such as the second molar 1a in FIG. 2a) of the dentition 1. Therefore, with reference to the structural design of the attachment 10, for a case mentioned in the BACKGROUND that the attachment attaches to the labial-buccal side of the tooth, the retention effect of the attachment 10 on the orthodontic appliance 100 is greatly improved, to prevent the orthodontic appliance 100 from accidentally falling off when a behavior of the patient such as licking or pressing of the tongue occurs unconsciously.

Furthermore, preferably, the accommodating groove 101 may alternatively be located in a shell unit of the orthodontic appliance 100 (such as the first molar shell unit in FIG. 2a), which corresponds to a second-to-last tooth (such as the first molar in FIG. 2a).

In addition, preferably, referring to FIG. 2b, an extending direction of a distal groove surface 1011 of the accommodating groove 101 from a gingiva end 1011a of the distal groove surface 1011 to an occlusion end 1011b of the distal groove surface 1011 and a vertical surface VH of the long axis V of the shell unit 100a are at an angle k3 ranging from 45° to 90°. That is, the extending direction of a distal groove surface 1011 and the vertical surface VH may be in a relationship of being perpendicular to each other, or may be at an acute angle greater than or equal to 45° and the distal groove surface 1011 extends forward (that is, toward the mesial side) from the gingiva end 1011a of the distal groove surface 1011, or may be at an acute angle greater than or equal to 45° and the distal groove surface 1011 extends backward (that is, toward the distal side) from the gingiva end 1011a of the distal groove surface.

It can be understood that the distal groove surface 1011 of the accommodating groove 101 corresponds to the first retention area 121. Referring to FIG. 2c, a long axis V of the shell unit 100a corresponds to a long axis V1 of the tooth Ta. Therefore, a mounting orientation of the attachment 10 on the tooth 1a is equivalently fixed as follows: An extending direction of the first retention area 121 from a gingiva end (such as point P2 shown in FIG. 2c) of the first retention area 121 to an occlusion end (such as point P1 shown in FIG. 2c) of the first retention area 121 and a vertical surface VH1 of the long axis V1 of the tooth 1a are at an angle k31 ranging from 45° to 90°. That is, the extending direction of the first retention area 121 and the vertical surface VH1 may be in a relationship of being perpendicular to each other, or may be at an acute angle greater than or equal to 45° and the first retention area 121 extends forward (that is, toward the mesial side) from the gingiva end (such as point P2 shown in FIG. 2c) of the first retention area 121, or may be at an acute angle greater than or equal to 45° and the first retention area 121 extends backward (that is, toward the distal side) from the gingiva end (such as point P2 shown in FIG. 2c) of the first retention area 121, to further enhance the retention effect on the orthodontic appliance 100.

In another aspect, furthermore, preferably, referring to FIG. 2b, an extending direction of a gingival groove surface 1012 of the accommodating groove 101 from a distal end 1012a of the gingival groove surface 1012 to a mesial end 1012b of the gingival groove surface 1012 and the vertical surface VH of the long axis V of the shell unit 100a are at an angle k4 ranging from 0° to 30°. That is, the extending direction of a gingival groove surface 1012 and the vertical surface VH may be in a relationship of being parallel to each other, or may be at an acute angle smaller than or equal to 30° and the gingival groove surface 1012 extends upward (that is, toward the occlusion end) from the distal end 1012a of the gingival groove surface 1012, or may be at an acute angle smaller than or equal to 30° and the gingival groove surface 1012 extends downward (that is, toward the gingiva end) from the distal end 1012a of the gingival groove surface 1012.

It can be similarly understood that the gingival groove surface 1012 of the accommodating groove 101 corresponds to the third retention area 123. Referring to FIG. 2c, a mounting orientation of the attachment 10 on the tooth 1a is equivalently fixed as follows: An extending direction of the third retention area 123 from a distal end (such as point P3 shown in FIG. 2c) of the third retention area 123 to a mesial end (such as point P4 shown in FIG. 2c) of the third retention area 123 and the vertical surface VH1 of the long axis V1 of the tooth 1a are at an angle k41 ranging from 0° to 30°. That is, the extending direction of the third retention area 123 and the vertical surface VH1 may be in a relationship of being parallel to each other, or may be at an acute angle ≤30° and the third retention area 123 extends upward (that is, toward the occlusion end) from the distal end (such as point P3 shown in FIG. 2c) of the third retention area 123, or may be at an acute angle ≤30° and the third retention area 123 extends downward (that is, toward the gingiva end) from the distal end (such as point P3 shown in FIG. 2c) of the third retention area 123, to further enhance the retention effect on the orthodontic appliance 100.

Generally speaking, this embodiment has the following beneficial effects:

The retention surface 12 and the bottom surface 11 are arranged at an angle ranging from 60° to 90°, the first retention area 121 and the third retention area 123 are arranged at an angle ranging from 60° to 120° and connected through the arc-shaped second retention surface 122, and the upper edge 122a of the second retention area 122 defines the maximum height of the attachment 10, to integrally construct the wedge-shaped retention surface 12, enhance the retention effect on the orthodontic appliance, so that the pressure between the orthodontic appliance and the attachment 10 may be higher after being pressed more tightly against each other in an accidental fall-off movement, to ensure a sufficient retention effect on the orthodontic appliance and provide a more obvious retention advantage compared with the existing attachment particularly for a patient with a short dental crown, for example, a young patient;

In addition, based on the structural design of the attachment 10, with reference to collaboration between the attachment 10 and the orthodontic appliance 100, particularly for a case that the attachment attaches to the labial-buccal side of the tooth, the retention effect of the attachment 10 on the orthodontic appliance 100 can be greatly improved, to prevent the orthodontic appliance 100 from accidentally falling off when a behavior of the patient such as licking or pressing of the tongue occurs unconsciously.

Referring to FIG. 3a to FIG. 3c, a preferred embodiment 2 of an attachment provided in this application is shown. An only difference between this embodiment and the foregoing embodiment 1 is: an angle k1 between a retention surface and a bottom surface. Only technical content related to the difference is described below, and the remaining technical content the same as that in the embodiment 1 is not described again in detail.

In the foregoing embodiment 1, the angle k1 between the retention surface 12 and the bottom surface 11 is 90°, that is, the retention surface 12 extends upward along a straight line perpendicular to the bottom surface 11 and parallel to the normal of the bottom surface 11.

However, in this embodiment 2, an angle k1 between a retention surface 22 and a bottom surface 21 is an acute angle greater than or equal to 60°, that is, each of a first retention area 221, a second retention area 222, and a third retention area 223 and the bottom surface 21 are arranged at an acute angle greater than or equal to 60°.

Preferably, in this embodiment, starting from a partial edge (that is, an edge P1-P2-P3-P4) of the bottom surface 21, the retention surface 22 is at an acute angle greater than or equal to 60° with the bottom surface 21 and extends upward along a straight line. For example, as shown in the accompanying drawing, the retention surface 22 is set as a part of a straight-line curved surface. Referring to FIG. 3a, the straight-line curved surface is constructed with a straight line T-T0 at an acute angle greater than or equal to 60° with the bottom surface 21 (that is, a line segment in the retention surface 22 that passes through the highest point T) used as a generatrix and with the partial edge of the bottom surface 21 (that is, the edge P1-P2-P3-P4) used as a guiding line.

Given that the first retention area 221 is a straight line on the cross-section perpendicular to the normal of the bottom surface 21, the third retention area 223 is a straight line on the cross-section perpendicular to the normal of the bottom surface 21, and the second retention area 222 is arc-shaped on the cross-section perpendicular to the normal of the bottom surface 21, this embodiment is the same as the embodiment 1 in that, each of the first retention area 221 and the third retention area 223 is a plane and the second retention area 122 is a cylindrical arc surface. Certainly, the configurations of the first retention area 221 and the third retention area 223 are not limited thereto, and may alternatively be, for example, changed based on the embodiment 2 as follows: Each of the first retention area 221 and the third retention area 223 is either of a concave curved line and a convex curved line on the cross-section perpendicular to the normal of the bottom surface 21.

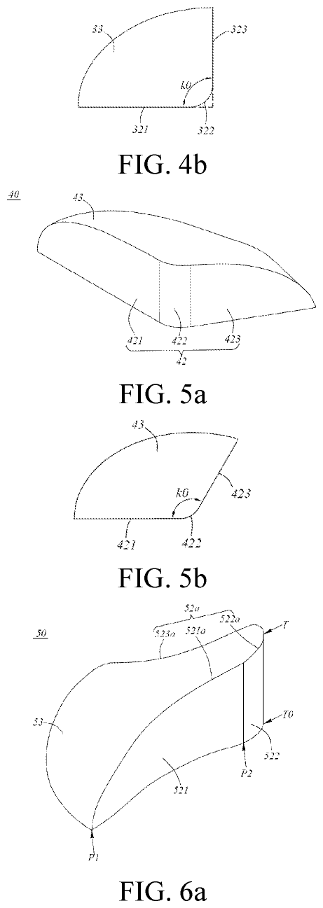

Referring to FIG. 4a and FIG. 4b, a preferred embodiment 3 of an attachment provided in this application is shown, and referring to FIG. 5a and FIG. 5b, a preferred embodiment 4 of an attachment provided in this application is shown. An only difference between each of the two embodiments and the foregoing embodiment 1 is: an angle k0 between a first retention area and a third retention area. Only technical content related to the difference is described below, and the remaining technical content the same as that in the embodiment 1 is not described again in detail.

In the foregoing embodiment 1, the angle k0 between the first retention area 121 and the third retention area 123 is an acute angle greater than or equal to 60°.

However, in this embodiment 3 shown in FIG. 4a and FIG. 4b, an angle k0 between a first retention area 321 and a third retention area 323 is a right angle. Given that each of the first retention area 321 and the third retention area 323 is a plane, the first retention area 321 and the third retention area 323 are perpendicular to each other.

Similarly, in this embodiment 4 shown in FIG. 5a and FIG. 5b, an angle k0 between a first retention area 421 and a third retention area 423 is an obtuse angle smaller than or equal to 120°. Given that each of the first retention area 421 and the third retention area 423 is a plane, the first retention area 421 and the third retention area 423 are at an obtuse angle.

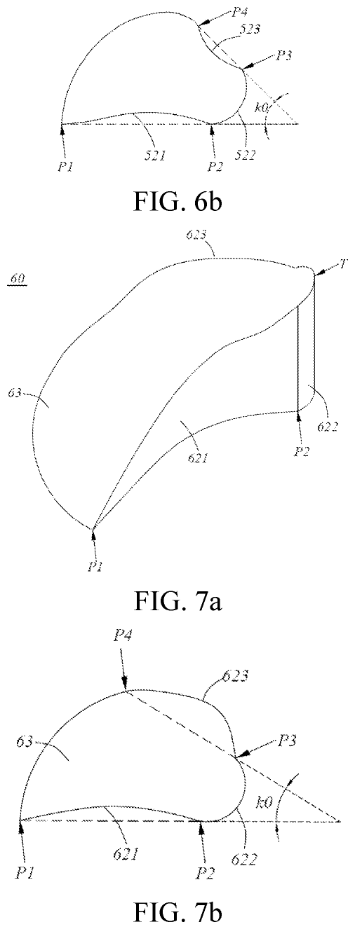

Referring to FIG. 6a to FIG. 6b, a preferred embodiment 5 of an attachment provided in this application is shown. An only difference between this embodiment and the foregoing embodiment 1 is: respective configurations of a first retention area and a third retention area on a cross-section perpendicular to a normal of a bottom surface. Only technical content related to the difference is described below, and the remaining technical content the same as that in the embodiment 1 is not described again in detail.

In the foregoing embodiment 1, each of the first retention area 121 and the third retention area 123 is a straight line on the cross-section perpendicular to the normal of the bottom surface 11. Given that the retention surface 12 extends upward in a straight line perpendicular to the bottom surface 11, each of the first retention area 121 and the third retention area 123 is a plane.

However, in this embodiment 5, referring to FIG. 6a and FIG. 6b, a first retention area 521 is a concave curved line on a cross-section perpendicular to a normal of a bottom surface of an attachment 50. Given that a retention surface of the attachment 50 extends upward in a straight line perpendicular to the bottom surface of the attachment 50, the first retention area 521 is integrally a concave curved surface perpendicular to the bottom surface of the attachment 50.

Similarly, a third retention area 523 is also a concave curved line on the cross-section perpendicular to the normal of the bottom surface of the attachment 50. Given that a retention surface of the attachment 50 extends upward in a straight line perpendicular to the bottom surface of the attachment 50, the third retention area 523 is integrally a concave curved surface perpendicular to the bottom surface of the attachment 50.

Therefore, for an angle k0 between the first retention area 521 and the third retention area 523, on a partial edge (that is, an edge P1-P2-P3-P4) of the bottom surface of the attachment 50, there are a connection line between two farthest endpoints P1 and P2 of the first retention area 521 (that is, a dashed line segment P1-P2 in FIG. 6b, represented below with a connection line P1-P2), and a connection line between two farthest endpoints P3 and P4 of the third retention area 523 (that is, a dashed line segment P3-P4 in FIG. 6b, represented below with a connection line P3-P4), and an angle k0 between the connection line P-P2 and the connection line P3-P4, defines the “angle k0 between the first retention area 521 and the third retention area 523”. The value of the angle k0 in this embodiment is an acute angle greater than or equal to 60° the same as that in the embodiment 1, and certainly may alternatively be any value ranging from 60° to 120° in a changed implementation.

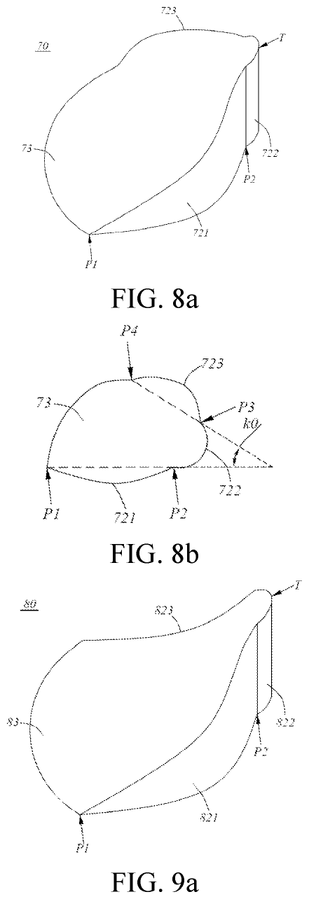

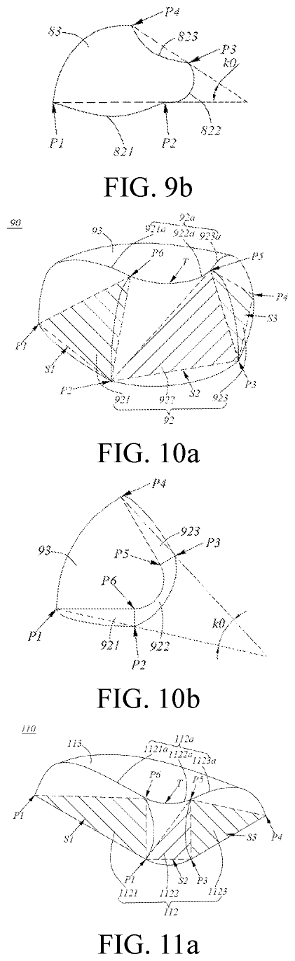

In the foregoing embodiment 5, each of the first retention area 521 and the third retention area 523 is a concave curved line on the cross-section perpendicular to the normal of the bottom surface of the attachment 50. However, respective configurations of a first retention area and a third retention area of this application on a cross-section perpendicular to a normal of a bottom surface are not limited thereto. For example, referring to FIG. 7a and FIG. 7b, a preferred embodiment 6 of an attachment provided in this application is shown, which is changed based on the embodiment 5 as follows: A third retention area 623 is a convex curved line on a cross-section perpendicular to a normal of a bottom surface of an attachment 60. For another example, referring to FIG. 8a and FIG. 8b, a preferred embodiment 7 of an attachment provided in this application is shown, which is changed based on the embodiment 5 as follows: Each of a first retention area 721 and a third retention area 723 is a convex curved line on a cross-section perpendicular to a normal of a bottom surface of an attachment 70. For still another example, referring to FIG. 9a and FIG. 9b, a preferred embodiment 8 of an attachment provided in this application is shown, which is changed based on the embodiment 5 as follows: A first retention area 821 is a convex curved line on a cross-section perpendicular to a normal of a bottom surface of an attachment 80. In addition, each of the first retention area and a third retention area may alternatively be a straight line on the cross-section perpendicular to the normal of the bottom surface, as shown in the embodiment 1. Generally, in this application, on the cross-section perpendicular to the normal of the bottom surface, each of the first retention area and the third retention area may be any one of a straight line, a concave curved line, or a convex curved line. None of these combinations and changes departs from the technical aim of this application.

Referring to FIG. 10a to FIG. 10b, a preferred embodiment 9 of an attachment provided in this application is shown. An only difference between this embodiment and the foregoing embodiment 1 is: respective configurations of a first retention area and a third retention area on a cross-section perpendicular to a normal of a bottom surface, a configuration of a retention surface extending upward from a partial edge of the bottom surface, and an angle between the retention surface and the bottom surface. Only technical content related to the difference is described below, and the remaining technical content the same as that in the embodiment 1 is not described again in detail.

In the foregoing embodiment 1, the first retention area 121 and the third retention area 123 are straight lines on the cross-section perpendicular to the normal of the bottom surface 11.

However, in this embodiment, referring to FIG. 10a and FIG. 10b, each of a first retention area 921 and a third retention area 923 is a convex curved line on a cross-section perpendicular to a normal of a bottom surface 91.

Therefore, for an angle k0 between the first retention area 921 and the third retention area 923, on a partial edge (that is, an edge P1-P2-P3-P4) of the bottom surface 91, there are a connection line between two farthest endpoints P1 and P2 of the first retention area 921 (that is, a dashed line segment P1-P2 in FIG. 10b, represented below with a connection line P1-P2), and a connection line between two farthest endpoints P3 and P4 of the third retention area 923 (that is, a dashed line segment P3-P4 in FIG. 10b, represented below with a connection line P3-P4), and an angle k0 between the connection line P-P2 and the connection line P3-P4, defines the “angle k0 between the first retention area 921 and the third retention area 923”. The value of the angle k0 in this embodiment is an acute angle greater than or equal to 60° the same as that in the embodiment 1, and certainly may alternatively be any value ranging from 60° to 120° in a changed implementation.

In addition, in the foregoing embodiment 1, the retention surface 12 extends upward in a straight line perpendicular to the bottom surface 11.

However, in this embodiment, a retention surface 92 extends upward in a convex curved shape from the partial edge (that is, the edge P1-P2-P3-P4) of the bottom surface 91, until reaching an upper edge 92a thereof. Specifically, the first retention area 921 extends upward in a convex curved shape from an edge P1-P2 of the bottom surface 91, until reaching an upper edge 921a thereof; the second retention area 922 extends upward in a convex curved shape from an edge P2-P3 of the bottom surface 91, until reaching an upper edge 922a thereof; and the third retention area 923 extends upward in a convex curved shape from an edge P3-P4 of the bottom surface 91, until reaching an upper edge 923a thereof.

Therefore, similar to the foregoing embodiments 1 to 8, an angle k1 between the retention surface 92 and the bottom surface 91 is jointly defined by respective angles between the first retention area 921, the second retention area 922, and the third retention area 923 and the bottom surface 91.

For the angle between the first retention area 921 and the bottom surface 91, a higher endpoint P6 of the upper edge 921a thereof, and an endpoint P1 and an endpoint P2 on the edge P1-P2 of the bottom surface 91 construct a plane S1, and the plane S1 defines the angle between the first retention area 921 and the bottom surface 91. To be specific, based on an angle between the plane S1 and the bottom surface 91, the angle between the first retention area 921 and the bottom surface 91 is obtained, and is, for example, an acute angle greater than or equal to 60° in the accompanying drawing, or certainly may be a right angle 90° or an obtuse angle smaller than or equal to 120° in a changed implementation.

For the angle between the second retention area 922 and the bottom surface 91, a higher endpoint P5 of the upper edge 922a thereof, and an endpoint P3 and an endpoint P2 on the edge P2-P3 of the bottom surface 91 construct a plane S2, and the plane S2 defines the angle between the second retention area 922 and the bottom surface 91. To be specific, based on an angle between the plane S2 and the bottom surface 91, the angle between the second retention area 922 and the bottom surface 91 is obtained, and is, for example, an acute angle greater than or equal to 60° in the accompanying drawing, or certainly may be a right angle 90° or an obtuse angle smaller than or equal to 120° in a changed implementation.

For the angle between the third retention area 923 and the bottom surface 91, a higher endpoint P5 of the upper edge 923a thereof, and an endpoint P3 and an endpoint P4 on the edge P3-P4 of the bottom surface 91 construct a plane S3, and the plane S3 defines the angle between the third retention area 923 and the bottom surface 91. To be specific, based on an angle between the plane S3 and the bottom surface 91, the angle between the third retention area 923 and the bottom surface 91 is obtained, and is, for example, an acute angle greater than or equal to 60° in the accompanying drawing, or certainly may be a right angle 90° or an obtuse angle smaller than or equal to 120° in a changed implementation.

Therefore, in the example in the accompanying drawing, the angle (defined by the angle between the plane S1 and the bottom surface 91) between the first retention area 921 and the bottom surface 91 is an acute angle greater than or equal to 60°, the angle (defined by the angle between the plane S2 and the bottom surface 91) between the second retention area 922 and the bottom surface 91 is an acute angle greater than or equal to 60°, and the angle (defined by the angle between the plane S3 and the bottom surface 91) between the third retention area 923 and the bottom surface 91 is an acute angle greater than or equal to 60°, to jointly define the angle between the retention surface 92 and the bottom surface 91 as an acute angle greater than or equal to 60° in this embodiment.

Referring to FIG. 11a to FIG. 11b, a preferred embodiment 10 of an attachment provided in this application is shown. An only difference between this embodiment and the foregoing embodiment 1 is: a configuration of a retention surface extending upward from a partial edge of a bottom surface. Only technical content related to the difference is described below, and the remaining technical content the same as that in the embodiment 1 is not described again in detail.

In the foregoing embodiment 1, the retention surface 12 extends upward in a straight line perpendicular to the bottom surface 11.

However, in this embodiment, a retention surface 112 extends upward in a concave curved shape from a partial edge (that is, an edge P1-P2-P3-P4) of a bottom surface 111, until reaching an upper edge 112a thereof. Specifically, the first retention area 1121 extends upward in a convex curved shape from an edge P1-P2 of the bottom surface 111, until reaching an upper edge 1121a thereof; the second retention area 1122 extends upward in a convex curved shape from an edge P2-P3 of the bottom surface 111, until reaching an upper edge 1122a thereof; and the third retention area 1123 extends upward in a convex curved shape from an edge P3-P4 of the bottom surface 111, until reaching an upper edge 1123a thereof.

Therefore, similar to the foregoing embodiments 1 to 9, an angle k1 between the retention surface 112 and the bottom surface 111 is jointly defined by respective angles between the first retention area 1121, the second retention area 1122, and the third retention area 1123 and the bottom surface 111. In this case,

For the angle between the first retention area 1121 and the bottom surface 111, a higher endpoint P6 of the upper edge 1121a thereof, and an endpoint P1 and an endpoint P2 on the edge P1-P2 of the bottom surface 111 construct a plane S1, and the plane S1 defines the angle between the first retention area 1121 and the bottom surface 111. To be specific, based on an angle between the plane S1 and the bottom surface 111, the angle between the first retention area 1121 and the bottom surface 111 is obtained, and is, for example, a right angle 90° in the accompanying drawing, or certainly may be an obtuse angle smaller than or equal to 120° or an acute angle greater than or equal to 60° in a changed implementation.

For the angle between the second retention area 1122 and the bottom surface 111, a higher endpoint P5 of the upper edge 1122a thereof, and an endpoint P3 and an endpoint P2 on the edge P2-P3 of the bottom surface 111 construct a plane S2, and the plane S2 defines the angle between the second retention area 1122 and the bottom surface 111. To be specific, based on an angle between the plane S2 and the bottom surface 111, the angle between the second retention area 1122 and the bottom surface 111 is obtained, and is, for example, a right angle 90° in the accompanying drawing, or certainly may be an acute angle greater than or equal to 60° or an obtuse angle smaller than or equal to 120° in a changed implementation.

For the angle between the third retention area 1123 and the bottom surface 111, a higher endpoint P5 of the upper edge 1123a thereof, and an endpoint P3 and an endpoint P4 on the edge P3-P4 of the bottom surface 111 construct a plane S3, and the plane S3 defines the angle between the third retention area 1123 and the bottom surface 111. To be specific, based on an angle between the plane S3 and the bottom surface 111, the angle between the third retention area 1123 and the bottom surface 111 is obtained, and is, for example, a right angle 90° in the accompanying drawing, or certainly may be an obtuse angle smaller than or equal to 120° or an acute angle greater than or equal to 60° in a changed implementation.

Therefore, in the example in the accompanying drawing, the angle (defined by the angle between the plane S1 and the bottom surface 111) between the first retention area 1121 and the bottom surface 111 is a right angle 90°, the angle (defined by the angle between the plane S2 and the bottom surface 111) between the second retention area 1122 and the bottom surface 111 is a right angle 90°, and the angle (defined by the angle between the plane S3 and the bottom surface 111) between the third retention area 1123 and the bottom surface 111 is a right angle 90°, to jointly define the angle between the retention surface 112 and the bottom surface 111 as a right angle 90° in this embodiment, or certainly an acute angle greater than or equal to 60° or an obtuse angle smaller than or equal to 120° in a changed implementation.

In each of the embodiments of the attachments shown in FIG. 3a to FIG. 11b, as shown in the embodiment 1, the attachment 10 may combine with the orthodontic appliance 100, that is, collaborate with the orthodontic appliance 100, to perform retention on the appliance 100. Details are not described again.

In addition, the specific configurations of the first retention area, the second retention area, and the third retention area in the embodiments may be implemented in a crossed or replaceable manner. For example, the first retention area in the embodiment 1 is not changed, while the second retention area or the third retention area is changed into that in any one of the embodiments 2 to 10; or the first retention area in the embodiment 1 is changed into that in any one of the embodiments 2 to 10, while the second retention area or the third retention area is not changed. None of these change manners departs from the technical aim of this application.

Generally, compared with the prior art, this application has the following beneficial effects:

The retention surface and the bottom surface are arranged at an angle ranging from 60° to 120°, the first retention area and the third retention area are arranged at an angle ranging from 60° to 120° and connected through the arc-shaped second retention surface, and the upper edge of the second retention area defines the maximum height of the attachment, to integrally construct the wedge-shaped retention surface and enhance the retention effect on the orthodontic appliance, so that the pressure between the orthodontic appliance and the attachment may be higher after being pressed more tightly against each other in an accidental fall-off movement, to ensure a sufficient retention effect on the orthodontic appliance and provide a more obvious retention advantage compared with the existing attachment particularly for a patient with a short dental crown, for example, a young patient.

In addition, based on the structural design of the attachment, with reference to collaboration between the attachment and the orthodontic appliance, particularly for a case that the attachment attaches to the labial-buccal side of the tooth, the retention effect of the attachment on the orthodontic appliance can be greatly improved, to prevent the orthodontic appliance from accidentally falling off when a behavior of the patient such as licking or pressing of the tongue occurs unconsciously.

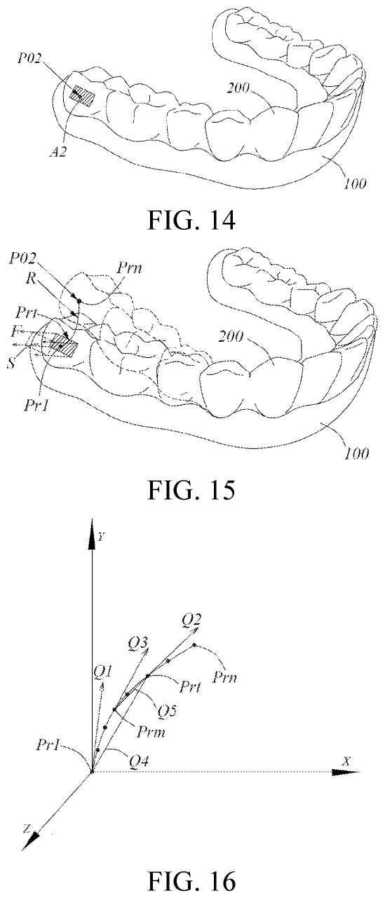

Referring to FIG. 12 to FIG. 19b, an embodiment 11 discloses a construction method for a retention attachment. The construction method is used for constructing a retention attachment in an invisible orthodontic appliance in a design stage, and particularly constructing a retention surface 12 and a bottom surface of the retention attachment. In addition, this embodiment further discloses a retention attachment 10 constructed with the construction method, and further discloses an invisible orthodontic appliance using the retention attachment 10.

Referring to FIG. 12, the construction method includes the following steps.

Step S101. Obtain a dentition model and a shell-shaped orthodontic appliance model matching the dentition model.

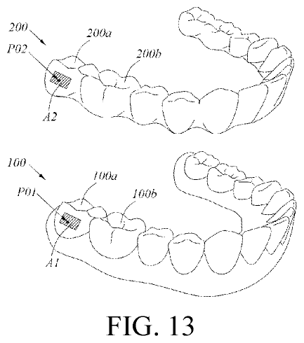

In the step, with reference to FIG. 13, for example, a dentition model 100 and a shell-shaped orthodontic appliance model 200 are obtained.

The dentition model 100 may be either of a maxillary dentition model and a mandibular dentition model, or may be a combination of a maxillary dentition model and a mandibular dentition model. In addition, the dentition model 100 may correspond to a complete dentition shown in FIG. 13, or may correspond to a part of a complete dentition in a changed implementation, for example, a dentition part remaining after removing incisors based on the complete dentition shown in FIG. 13. Certainly, this example is only an example for ease of understanding.

Conventionally, in a tooth orthodontics process, a dentition layout includes a series of intermediate layout states from a start layout state to a final layout state. In the step, the dentition layout of the dentition model 100 may be in the start layout state or any intermediate layout state, which is not limited.

In addition, more conventionally, in a tooth orthodontics process, a shell-shaped orthodontic appliance is worn on a dentition and is in an elastic deformation state, and a natural state (that is, an inelastic deformation state) of the shell-shaped orthodontic appliance is consistent with a next dentition layout state of the current dentition layout, thereby gradually correcting the current dentition layout into the next dentition layout state under the driving of the shell-shaped orthodontic appliance, to complete orthodontics in the stage.

In the step S101, as shown in FIG. 13, the shell-shaped orthodontic appliance model 200 matches the dentition model 100, that is, the shell-shaped orthodontic appliance model 200 may be worn on the dentition model 100, and has a theoretically natural state consistent with the next dentition layout state of the dentition model 100 in the tooth orthodontics plan. For example, when the dentition layout of the dentition model 100 is in the start layout state of the tooth orthodontics process, the shell-shaped orthodontic appliance model 200 matching the dentition model 100 is a model of a shell-shaped orthodontic appliance for correcting the dentition from the start layout state into the first intermediate layout state according to the tooth orthodontics plan; when the dentition layout of the dentition model 100 is in the last intermediate layout state of the tooth orthodontics process, the shell-shaped orthodontic appliance model 200 matching the dentition model 100 is a model of a shell-shaped orthodontic appliance for correcting the dentition from the last intermediate layout state into the final layout state according to the tooth orthodontics plan; and the rest can be deduced by analog, and enumeration is not performed.

Further, in the step S101, each of the dentition model 100 and the shell-shaped orthodontic appliance model 200 may be implemented as a digital model or a physical model.

For example, for the dentition model 100, in an implementation, a scanning device is used for intraoral scanning or scanning a conventional gypsum model obtained through casting after a mold is taken, to obtain dentition data. Based on the dentition data and with reference to dentition layout states in stages in the tooth orthodontics plan, a digital dentition model may be obtained. Therefore, the step S101 is implemented by obtaining the digital dentition model. In another implementation, after the foregoing digital dentition model is obtained, a physical dentition model may be obtained through 3D printing. Therefore, the step S101 is implemented by obtaining the physical dentition model. It can be understood that the two implementations are only an example, and the dentition model 100 may be implemented as a digital model or a physical model with another feasible technology known in this field.

For another example, for the shell-shaped orthodontic appliance model 200, in an implementation, based on an obtained digital dentition model 100 and according to a next dentition layout state of the dentition model 100 in the tooth orthodontics plan, a predetermined thickness parameter is given, and then a digital shell-shaped orthodontic appliance model 200 is obtained. Therefore, the step S101 is implemented by obtaining the digital shell-shaped orthodontic appliance model 200. In another implementation, after the digital shell-shaped orthodontic appliance model 200 is obtained, a physical shell-shaped orthodontic appliance model may be obtained through 3D printing and/or another molding technology. Therefore, the step S101 is implemented by obtaining the physical shell-shaped orthodontic appliance model. In still another implementation, based on an obtained digital dentition model 100 and according to a next dentition layout state of the dentition model 100 in the tooth orthodontics plan, a male mold is made, and then a physical shell-shaped orthodontic appliance model 200 is obtained by pressing on the male mold based on a heat press molding technology. Therefore, the step S101 is similarly implemented by obtaining the physical shell-shaped orthodontic appliance model 200. It can be understood that the three implementations are only an example, and the shell-shaped orthodontic appliance model 200 may be implemented as a digital model or a physical model with another feasible technology known in this field.

Step S102. Select a mounting position from an attachment mounting selectable area on the dentition model, and construct a retention attachment based on the mounting position.

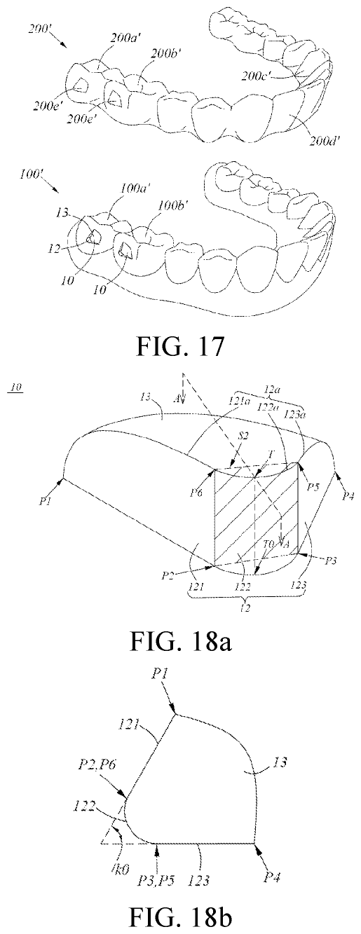

In the step, as shown in FIG. 13, for example, a mounting position P01 is selected from an attachment mounting selectable area A1 on the dentition model 100, and a retention attachment 10 is constructed based on the mounting position P01 (reference numerals are shown in FIG. 17).

Specifically, the mounting position P01 is located in the attachment mounting selectable area A1 (such as diagonal filling area shown in FIG. 13) on the dentition model 100, and the attachment mounting selectable area A1 represents a tooth surface on the dentition that may be used for mounting the retention attachment 10, and is preferably a flat tooth surface.

In this embodiment, the mounting position P01 may be determined according to an actual situation. For example, in a preferred implementation, big data analysis may be performed on a large quantity of historical cases of invisible orthodontic appliances, and a position of a retention surface in a historical case in which the retention effect is optimal (for example, the frequency of accidental fall-off of the orthodontic appliance is minimum, or the retention force during accidental fall-off of the orthodontic appliance is maximum) is used as the mounting position P01. Certainly, this is only an example. In an actual implementation, the mounting position P01 may alternatively be determined according to another factor or in another manner.

Specifically, the step S102 further includes the following sub-steps.

Sub-step S1021. Remove the shell-shaped orthodontic appliance model worn on the dentition model from the dentition model, and obtain a moving track of a reference position on the shell-shaped appliance model that corresponds to the mounting position.

In the sub-step S1021, referring to FIG. 13 to FIG. 15, for example, the shell-shaped appliance model 200 worn on the dentition model 100 is removed from the dentition model 100, and a moving track R of a reference position P02 on the shell-shaped orthodontic appliance model 200 that corresponds to the mounting position P01 is obtained.

Specifically, referring to FIG. 13, because of a matching relationship between the dentition model 100 and the shell-shaped orthodontic appliance model 200, the shell-shaped orthodontic appliance model 200 includes an attachment accommodating groove selectable area A2 corresponding to the position of the attachment mounting selectable area A1. The attachment accommodating groove selectable area A2 represents an area on the shell-shaped orthodontic appliance that may be used for arranging an attachment accommodating groove (for example, shown below by a reference numeral 200e′ in FIG. 17). In addition, the attachment accommodating groove selectable area A2 includes a reference position P02 corresponding to the position of the mounting position P01.

In the sub-step S1021, first, the shell-shaped orthodontic appliance model 200 is worn on the dentition model 100. It can be understood that when wearing in good condition, the attachment accommodating groove selectable area A2 just completely coincides with the attachment mounting selectable area A1, and the reference position P02 just completely coincides with the mounting position P01.

Further, referring to FIG. 15, the shell-shaped appliance model 200 is changed from a state of being worn on the dentition model 100 (shown by a solid line in FIG. 15) to a state of being removed from the dentition model 100 (shown by a dashed line in FIG. 15), and the process is defined as a removing process for ease of description. In the sub-step S1021, the moving track R of the reference position P02 is obtained in the removing process.

Preferably, as shown in FIG. 16, in the step of “obtaining a moving track of a reference position on the shell-shaped orthodontic appliance model that corresponds to the mounting position”, N coordinates of the reference position P02 under a space coordinate system are sequentially recorded (each coordinate is shown by a black point in FIG. 16), N≥2, the N coordinates are fit into one curved line R in sequence, and the curved line R forms the moving track R.

The “N coordinates” include a start coordinate of the reference position P02, and the start coordinate is a coordinate of the reference position P02 corresponding to a case that the shell-shaped orthodontic appliance model 200 is worn on the dentition model 100. For example, as shown in FIG. 16, the N coordinates are, for example, Pr1, . . . , and Prn, where the coordinate Pr1 is the start coordinate of the reference position P02.

In the space coordinate system X-Y-Z shown in FIG. 16, a long axis of the tooth 100a on which the mounting position P01 is located is defined as a Y axis, that is, the Y axis is parallel to the long axis of the tooth 100a, and a pointing direction from a gingiva end to an occlusion end is defined as a positive direction of the Y axis; a pointing direction perpendicular to the long axis of the tooth 100a and from a lingual surface of the tooth 100a to a labial-buccal surface of the tooth 100a is defined as a positive direction of the Z axis; and a pointing direction perpendicular to the long axis of the tooth 100a and from the tooth 100a to a neighboring tooth 100b before the tooth 100a (or a pointing direction from a distal side of the tooth 100a to a mesial side thereof) is defined as a positive direction of the X axis. Certainly, FIG. 16 shows only an example of the space coordinate system in this application. It may be learned in this field that the space coordinate system may be constructed in another direction as required. Details are not described again.

Further, in the step of “sequentially recording N coordinates of the reference position P02 under a space coordinate system”, starting from the start coordinate Pr1 of the reference position P02, as the removing process lasts, coordinates of the reference position P02 under the space coordinate system are obtained every period of time or every specific displacement. Specifically, for example, in the sub-step S1021, every period of time, for example, 0.1 s, coordinates of the reference position P02 under the space coordinate system are recorded, and therefore N coordinates Pr1, . . . , and Prn of the reference position P02 under the space coordinate system are obtained. Alternatively, in the sub-step S1021, every specific displacement, coordinates of the reference position P02 under the space coordinate system are recorded, and therefore N coordinates Pr1, . . . , and Prn of the reference position P02 under the space coordinate system are obtained.

Sub-step S1022. Establish a tangent line of a key position in the moving track or establish a direct connection line between two key positions in the moving track, and construct the retention attachment according to predetermined rules.

To be specific, in the sub-step S1022, a first auxiliary line is established based on a key position in the moving track R, and the retention attachment 10 is constructed according to the first auxiliary line.

The first auxiliary line is established in different implementations: For example, in an implementation, the first auxiliary line is a tangent line of a key position in the moving track R. In another implementation, the first auxiliary line is a direct connection line between two key positions in the moving track R.

Preferably, the key position is selected from a start position, an end position, and a transitional position, or certainly may be selected from other positions as required, and is not limited thereto. Referring to FIG. 16, the start position is a start point of the moving track R, that is, a position at which the reference position P02 is located when the shell-shaped orthodontic appliance model 200 is worn on the dentition model 100, for example, a position represented by the foregoing coordinate Pr1, and the “start position” is marked below as Pr1 for ease of description; the end position is a position Prt of the reference position P02 when leaving from a projection space S in a normal direction F (referring to a dashed arrow in FIG. 15) of the attachment mounting selectable area A1, that is, the end position Prt is defined by an intersection point of a boundary of the projection space S and the moving track R; and the transitional position is a position on the moving track R between the start position Pr1 and the end position Prt, and is, for example, a position Prm shown in FIG. 16.

Based on this, in the sub-step S1022, in an implementation, if the “establishing a tangent line of a key position in the moving track” is implemented, the establishing may be, for example, specifically: establishing a tangent line of the start position Pr1, as shown by Q1 in FIG. 16, or establishing a tangent line of the end position Prt, as shown by Q2 in FIG. 16, or establishing a tangent line of the transitional position, as shown by Q3 in FIG. 16. Then, the first auxiliary line is the tangent line Q1, Q2, or Q3. Certainly, when the key position is selected from other positions, the established tangent line also correspondingly changes, and enumeration is not performed.

In the sub-step S1022, in an implementation, if the “establishing a direct connection line between two key positions in the moving track” is implemented, the establishing may be, for example, specifically: establishing a direct connection line between the start position Pr1 and the end position Prt, as shown by Q4 in FIG. 16; or establishing a direct connection line between the start position Pr1 and the transitional position or between the end position Prt and the transitional position (as shown by Q5 in FIG. 16). Then, the first auxiliary line is the direct connection line Q4 or Q5. Certainly, when the two key positions are selected from other positions, the established direct connection line also correspondingly changes, and enumeration is not performed.

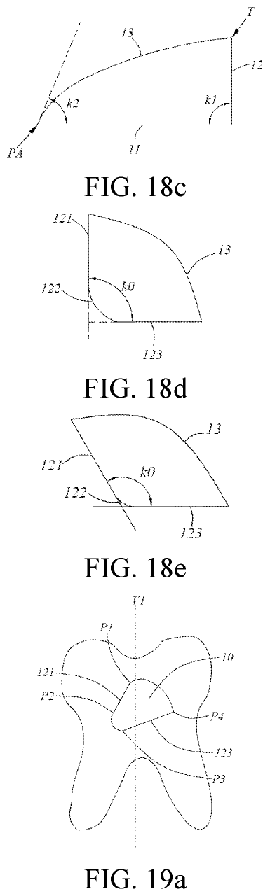

In this embodiment, referring to FIG. 17 and FIG. 18a, integrally, the retention attachment 10 includes a bottom surface 11, a retention surface 12, and a non-retention surface 13, and may be specifically set as a closed three-dimensional body defined by the bottom surface 11, the retention surface 12, and the non-retention surface 13. The retention surface 12 includes a distal retention surface 121, a corner retention surface 122, and a gingival retention surface 123 sequentially connected along a partial edge of the bottom surface 11 (that is, an edge P1-P2-P3-P4).

Further, in the sub-step S1022, when the retention attachment 10 is constructed, a rule 1 is satisfied: The bottom surface 11 fits the attachment mounting selectable area A1.

As described above, the attachment mounting selectable area A1 represents a tooth surface on the dentition that may be used for mounting the retention attachment 10; and correspondingly, the bottom surface 11 is a mounting surface of the retention attachment 10 that is used for attaching to a tooth. Therefore, the retention attachment 10 is constructed based on the rule 1, that is, the bottom surface 11 is designed to match the attachment mounting selectable area A1, so that the retention attachment 10 can be attached to the tooth surface corresponding to the attachment mounting selectable area A1 by the bottom surface 11.

It can be understood that in an embodiment, in a specific implementation of attaching to the tooth, the bottom surface 11 may be fit and fixed onto the tooth surface corresponding to the attachment mounting selectable area A1 in a sticking manner.

Further, in the sub-step S1022, when the retention attachment 10 is constructed, a rule 2 is further satisfied: An intersection line P3-P4 of the gingival retention surface 123 and the bottom surface 11 is a first straight line, an intersection line P3-P5 of the gingival retention surface 123 and the corner retention surface 122 includes a highest point P5 in a normal direction of the bottom surface 11, and a plane defined by the first straight line (referring to the intersection line P3-P4) and the highest point P5 is at an angle ranging from 60° to 90° with the first auxiliary line; or an intersection line P3-P5 of the gingival retention surface 123 and the corner retention surface 122 is a second straight line, an intersection line P3-P4 of the gingival retention surface and the bottom surface 11 includes a farthest point P4 away from the corner retention surface 122, and a plane defined by the second straight line (referring to the intersection line P3-P5) and the farthest point P4 is at an angle ranging from 60° to 90° with the first auxiliary line.

Specifically, the gingival retention surface 123 has the intersection line P3-P4 with the bottom surface 11; and the gingival retention surface 123 has the intersection line P3-P5 with the corner retention surface 122.

On the intersection line P3-P4, the point P4 is a farthest point away from the corner retention surface 122 and is also a farthest point away from the intersection line P3-P5, and the point P3 is a closest point intersecting with the corner retention surface 122 (that is, the point P3 is an intersection point of the intersection line P3-P4 and the corner retention surface 122) and is also an intersection point (or referred to as a common point) of the intersection line P3-P4 and the intersection line P3-P5. Similarly, on the intersection line P3-P5, the point P5 is a highest point of the intersection line P3-P5 in the normal direction of the bottom surface 11 and is also a farthest point away from the intersection line P3-P4, and the point P3 is a lowest point intersecting with the bottom surface 11 (that is, the point P3 is an intersection point of the intersection line P3-P5 and the bottom surface 11).

In the sub-step S1022, in an implementation, the rule 2 may be as follows: The intersection line P3-P4 is a straight line, and the plane defined by the intersection line P3-P4 and the point P5 is at an angle ranging from 60° to 90°, preferably 90°, with the first auxiliary line (for example, the tangent line Q1, Q2, or Q3, or the direct connection line Q4 or Q5), so that the gingival retention surface 123 of the retention attachment 10 is constructed based on the rule 2. Alternatively, the rule 2 may be as follows: The intersection line P3-P5 is a straight line, and the plane defined by the intersection line P3-P5 and the point P4 is at an angle ranging from 60° to 90°, preferably 90°, with the first auxiliary line (for example, the tangent line Q1, Q2, or Q3, or the direct connection line Q4 or Q5), so that the gingival retention surface 123 of the retention attachment 10 is constructed based on the rule 2.

In this way, in the construction method of this application, the bottom surface 11 is constructed based on the attachment mounting selectable area A1, and the gingival retention surface 123 is constructed based on the first auxiliary line. Therefore, the retention attachment 10 of an embodiment can greatly increase a retention force for an orthodontic appliance 200′ in contrast to the existing technology, to resolve the problem in the existing technology that an orthodontic appliance is prone to fall off because a retention attachment has an insufficient retention force for the orthodontic appliance.

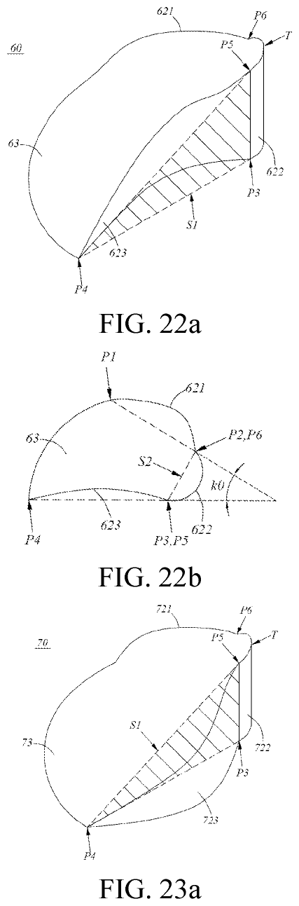

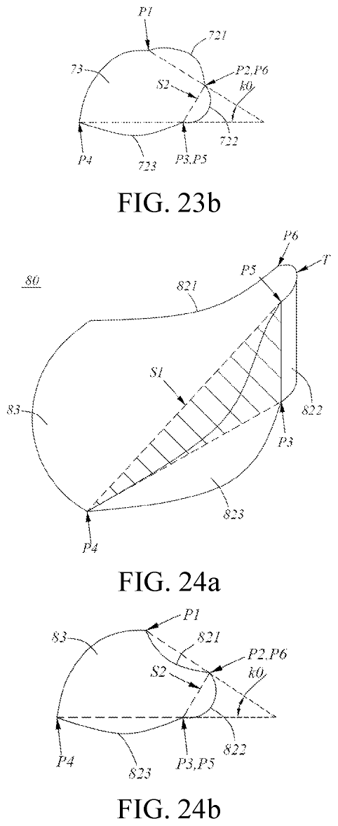

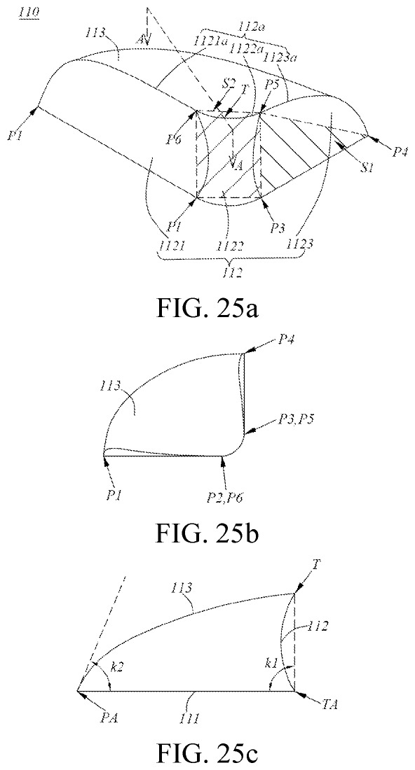

In this embodiment, as shown in the drawing, the gingival retention surface 123 is designed into a plane at an angle ranging from 60° to 90° with the first auxiliary line, and preferably the angle may be specifically an angle 90° (that is, the gingival retention surface 123 is perpendicular to the first auxiliary line); and the intersection line P3-P4 is a straight line. Certainly, in a changed implementation of this application, the gingival retention surface 123 may be designed into a concave curved surface satisfying the rule 2, for example, referring to the embodiment 13 shown in FIG. 21a, the embodiment 14 shown in FIG. 22a, and the embodiment 17 shown in FIG. 25a, or may be designed into a convex curved surface satisfying the rule 2, for example, referring to the embodiment 15 shown in FIG. 23a and the embodiment 16 shown in FIG. 24a. Details are described below.

Further, in a preferred implementation, in the step S102, the attachment mounting selectable area A1 is located on a labial-buccal surface of the dentition model 100, and correspondingly, the attachment accommodating groove selectable area A2 is located on a labial-buccal side of the shell-shaped orthodontic appliance model 200.

Correspondingly, the “removing the shell-shaped orthodontic appliance model worn on the dentition model from the dentition model” is preferably as follows: take a lingual side of the shell-shaped orthodontic appliance model as an acting area of an actuating force, and remove the shell-shaped orthodontic appliance model worn on the dentition model from the dentition model with the actuating force.

Therefore, the acting area of the actuating force is selected on the lingual side of the shell-shaped orthodontic appliance model 200, and the removing process of the shell-shaped orthodontic appliance model 200 is implemented based on this, so that the constructed retention attachment can improve the retention effect, and particularly prevent the orthodontic appliance from accidentally falling off when an incentive such as unconsciously licking or pressing of the tongue of the patient occurs.

It can be understood that the “acting area of the actuating force” is an originating position of the actuating force in the shell-shaped orthodontic appliance model 200. Preferably, in an implementation, a lingual gingiva edge of the shell-shaped orthodontic appliance model 200 is used as the acting area of the actuating force, and particularly as shown in the drawing, a lingual gingiva edge midpoint of a last molar shell unit 200a of the shell-shaped orthodontic appliance model 200 is used as the acting area of the actuating force.

Certainly, in a changed implementation, the acting area of the actuating force is not limited to the lingual gingiva edge, nor is limited to the last molar shell unit 200a, another proper position (for example, a second-to-last molar shell 200b) on the shell-shaped orthodontic appliance model 200 may alternatively be used as the acting area of the actuating force, and enumeration is not performed.

In a specific implementation, when each of the dentition model 100 and the shell-shaped orthodontic appliance model 200 is implemented as a physical model, a force may be applied to the lingual side of the shell-shaped orthodontic appliance model 200 through a tensile test machine, to remove the shell-shaped orthodontic appliance model 200 worn on the dentition model 100 from the dentition model 100. Alternatively, when each of the dentition model 100 and the shell-shaped orthodontic appliance model 200 is implemented as a digital model, the actuating force may be simulated with a simulation technology, to remove the shell-shaped orthodontic appliance model 200 worn on the dentition model 100 from the dentition model 100.

Further, the attachment mounting selectable area A1 is further located on any one, two, or more of the molars and the premolars of the dentition model 100. To describe the construction method of this implementation, the accompanying drawing shows only an example in which the attachment mounting selectable area A1 is located on the last molar (that is, the tooth 100a) of the dentition model 100, while in an actual implementation, the tooth on which the attachment mounting selectable area A1 is located is not limited thereto.

It can be understood that corresponding to the position of the attachment mounting selectable area A1, the attachment accommodating groove selectable area A2 is located on any one, two, or more of molar shell units corresponding to the molars and premolar shell units corresponding to the premolars of the shell-shaped orthodontic appliance model 200. To describe the construction method of this implementation, the accompanying drawing shows only an example in which the attachment accommodating groove selectable area A2 is located on the last molar shell unit 200a of the shell-shaped orthodontic appliance model 200. In addition, the actuating force is a vector parameter. In an implementation, the actuating force includes a component pointing to the occlusion end along the long axis and a component pointing to the labial-buccal surface perpendicular to the long axis, that is, the actuating force is in a direction of being at a non-zero angle with the long axis of the tooth 100a on which the attachment mounting selectable area A1 is located, pointing to the occlusion end from the gingiva end, and pointing to the labial-buccal surface from the lingual surface. Therefore, the retention attachment constructed based on the actuating force can further avoid a case that the orthodontic appliance falls off because of licking or pressing of the tongue, to greatly improve the retention effect on the orthodontic appliance. Certainly, in a changed implementation, the actuating force may alternatively point to the occlusion end along the long axis, that is, point to the occlusion end of the tooth 100a along the long axis of the tooth 100a on which the attachment mounting selectable area A1 is located.

Further, for the intersection line P3-P4 of the gingival retention surface 123 and the bottom surface 11, on the projection surface in the normal direction of the bottom surface 11, a direct connection line between the point P3 and the point P4 is at an angle ranging from 60° to 90° with the long axis of the tooth 100a on which the attachment mounting selectable area A1 is located. To be specific, on the projection surface in the normal direction of the bottom surface 11, the direct connection line between the point P3 and the point P4 may be: perpendicular to the long axis of the tooth 100a on which the attachment mounting selectable area A1 is located; or extending toward the occlusion surface of the tooth 100a in a state of being at an acute angle greater than or equal to 60° with the long axis of the tooth 100a on which the attachment mounting selectable area A1 is located from the point P3 to the point P4; or extending toward the gingiva of the tooth 100a in a state of being at an acute angle greater than or equal to 60° with the long axis of the tooth 100a on which the attachment mounting selectable area A1 is located from the point P3 to the point P4.

Further, the distal retention surface 121 has the intersection line P1-P2 with the bottom surface 11, and has the intersection line P2-P6 with the corner retention surface 122.

On the intersection line P1-P2, the point P1 is an extremely far point away from the corner retention surface 122 and is also an extremely far point away from the intersection line P2-P6, and the point P2 is an extremely close point intersecting with the corner retention surface 122 (that is, the point P2 is an intersection point of the intersection line P1-P2 and the corner retention surface 122) and is also an intersection point (or referred to as a common point) of the intersection line P1-P2 and the intersection line P2-P6. Similarly, on the intersection line P2-P6, the point P6 is a highest point of the intersection line P2-P6 in the normal direction of the bottom surface 11 and is also a farthest point away from the intersection line P1-P2, and the point P2 is a lowest point intersecting with the bottom surface 11 (that is, the point P2 is an intersection point of the intersection line P2-P6 and the bottom surface 11).

Preferably, in the sub-step S1022, referring to FIG. 18b, when the retention attachment 10 is constructed, a rule 3 is further satisfied: On a projection surface in the normal direction of the bottom surface 11, a direct connection line from the point P2 to the point P1 is at an angle k0 ranging from 60° to 120° with a direct connection line from the point P3 to the point P4.

It can be understood that the rule 3 includes three different implementations: Implementation 1, in an embodiment shown in FIG. 18b, on the projection surface in the normal direction of the bottom surface 11, the angle k0 is an acute angle greater than or equal to 60°. Implementation 2, as shown in FIG. 18d, as a simple changed embodiment of FIG. 18b, on the projection surface in the normal direction of the bottom surface 11, the angle k0 is a right angle. Implementation 3, as shown in FIG. 18e, as another simple changed embodiment of FIG. 18b, on the projection surface in the normal direction of the bottom surface 11, the angle k0 is an obtuse angle smaller than or equal to 120°.

Therefore, based on the rule 1 and the rule 2, the retention attachment 10 is further constructed according to the rule 3. Specifically, the distal retention surface 121 of the retention attachment 10 is constructed based on the rule 3, so that the retention attachment 10 is a wedge-shaped structure, to further enhance the retention effect on the orthodontic appliance 200′, and the pressure between the orthodontic appliance 200′ and the retention attachment 10 may be higher after being pressed more tightly against each other in an accidental fall-off movement.

Further, for the intersection line P1-P2 of the distal retention surface 121 and the bottom surface 11, on the projection surface in the normal direction of the bottom surface 11, a direct connection line between the point P1 and the point P2 is at an angle ranging from 0° to 45° with the long axis of the tooth 100a on which the attachment mounting selectable area A1 is located. To be specific, on the projection surface in the normal direction of the bottom surface 11, the direct connection line between the point P1 and the point P2 may be: parallel to the long axis of the tooth 100a on which the attachment mounting selectable area A1 is located; or extending forward (that is, toward the mesial side of the tooth 100a) in a state of being at an acute angle smaller than or equal to 45° with the long axis of the tooth 100a on which the attachment mounting selectable area A1 is located from the point P2 to the point P1; or extending backward (that is, toward the distal side of the tooth 100a) in a state of being at an acute angle smaller than or equal to 45° with the long axis of the tooth 100a on which the attachment mounting selectable area A1 is located from the point P2 to the point P1.

Further, in this embodiment, as shown in the drawing, the distal retention surface 121 is designed into a plane, and has an intersection line P1-P2 in a straight line with the bottom surface 11. Certainly, in a changed implementation of this application, the distal retention surface 121 may be designed into a concave curved surface satisfying the rule 3, for example, referring to the embodiment 13 shown in FIG. 21a, the embodiment 16 shown in FIG. 24a, and the embodiment 17 shown in FIG. 25a, or may be designed into a convex curved surface satisfying the rule 3, for example, referring to the embodiment 14 shown in FIG. 22a and the embodiment 15 shown in FIG. 23a. Details are described below.

In an implementation, the corner retention surface 122 has the intersection line P2-P3 with the bottom surface 11. Preferably, the step S102 further includes a sub-step S1023: establish a second auxiliary line different from the first auxiliary line, wherein the second auxiliary line is a tangent line of a key position or a direct connection line between two key positions in the moving track.

Similar to the foregoing first auxiliary line, the second auxiliary line is also established in different implementations: For example, in an implementation, the second auxiliary line is a tangent line of a key position in the moving track R. In another implementation, the second auxiliary line is a direct connection line between two key positions in the moving track R. In addition, during establishment of the second auxiliary line, the key position may be similarly selected from the start position, the end position, the transitional position, or other positions determined as required.

That the second auxiliary line is different from the first auxiliary line means:

If the first auxiliary line is a tangent line of a key position, the second auxiliary line may be a tangent line of another key position or may be a direct connection line between two key positions. Using FIG. 16 as an example, if the first auxiliary line is the tangent line Q1, the second auxiliary line may not be the tangent line Q1 but may be the tangent line Q2, the tangent line Q3, the direct connection line Q4, or the direct connection line Q5.

Or if the first auxiliary line is a direct connection line of two key positions, the second auxiliary line may be a direct connection line between another two key positions or may be a tangent line of a key position. Using FIG. 16 as an example, if the first auxiliary line is the direct connection line Q4, the second auxiliary line may not be the direct connection line Q4 but may be the tangent line Q1, the tangent line Q2, the tangent line Q3, or the direct connection line Q5.

In the sub-step S1023, the retention attachment 10 further satisfies a rule 4: a plane S2 defined by the endpoint P2 and the endpoint P3 of the intersection line P2-P3, and the point P5 is at an angle ranging from 60° to 90°, preferably 90°, with the second auxiliary line. Therefore, based on the second auxiliary line, the retention attachment 10 is constructed, and particularly the corner retention surface 122 of the retention attachment 10 is constructed, so that the retention force of the retention attachment 10 for the orthodontic appliance 200′ can be further enhanced, to resolve the problem in the existing technology that an orthodontic appliance is prone to fall off because a retention attachment has an insufficient retention force for the orthodontic appliance. In this preferred embodiment, as shown in the drawing, the corner retention surface 122 is designed into a shape of a convex arc on the cross-section perpendicular to the normal direction of the bottom surface 11, and particularly in a shape of a convex circular arc. Certainly, the structural style of the corner retention surface 122 is not limited thereto, and may alternatively be a plane at an angle ranging from 60° to 90° with the second auxiliary line.

Further, in a preferable implementation, the first auxiliary line is set as a tangent line Q1 of the start position Pr1, and the second auxiliary line is set as a direct connection line Q4 between the start position Pr1 and the end position Prt. Therefore, to be specific, the orientation of the gingival retention surface 123 of the retention attachment 10 is designed based on the tangent line Q1 of the start position Pr1, and the orientation of the corner retention surface 122 of the retention attachment 10 is designed based on the direct connection line Q4 between the start position Pr1 and the end position Prt, so that the retention force can be further enhanced, to ensure the retention effect of the retention attachment 10 on the orthodontic appliance 200′.

Further, referring to FIG. 18a, the retention surface 12 extends gradually away from the bottom surface 11 from the partial edge (specifically, the edge P1-P2-P3-P4) of the bottom surface 11, until reaching an upper edge 12a of the retention surface 12, and the upper edge 12a defines a maximum height of the retention attachment 10 in the normal direction of the bottom surface 11. In this embodiment, specifically, an upper edge 122a of the corner retention surface 122 defines a maximum height of the retention attachment 10 in the normal direction of the bottom surface 11, and a point T in the upper edge 122a is, for example, a highest point of the retention attachment 10 in the normal direction of the bottom surface 11. Certainly, in a changed implementation, the highest point T may alternatively be located in an upper edge 123a of the gingival retention surface 123 or an upper edge 121a of the distal retention surface 121.

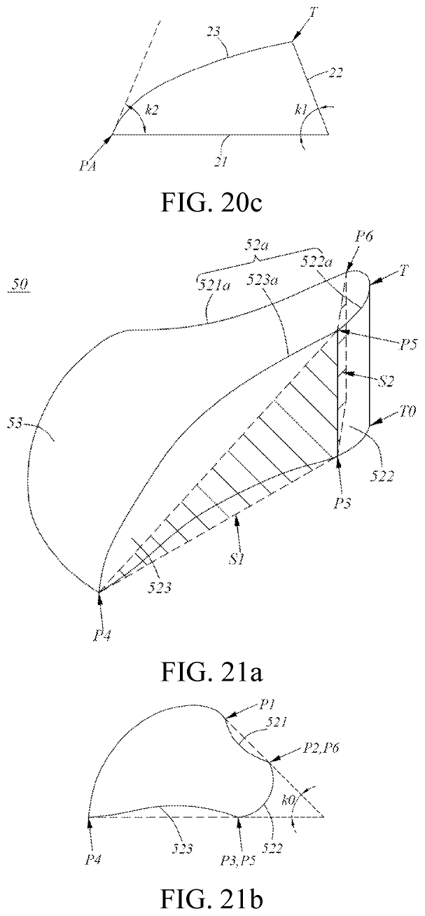

Preferably, each of the distal retention surface 121, the corner retention surface 122, and the gingival retention surface 123 may be set as: being arranged at an angle ranging from 60° to 120° with the bottom surface 11. From a different perspective, each of the distal retention surface 121, the corner retention surface 122, and the gingival retention surface 123 extends away from the bottom surface 11 along a straight line at an angle ranging from 60° to 120° with the bottom surface 11. Therefore, the retention surface 12 may provide a larger retention force to the orthodontic appliance 200′, to implement retention of the orthodontic appliance 200′ on a dentition 100′. Further, the angle between each of the distal retention surface 121, the corner retention surface 122, and the gingival retention surface 123 and the bottom surface 11 may preferably range from 60° to 90°, and more preferably range from 75° to 90°. In addition, in a changed implementation, each of the distal retention surface 121, the corner retention surface 122, and the gingival retention surface 123 may alternatively be set as extending away from the bottom surface 11 along a curved line, as shown in the embodiment shown in FIG. 25a. In addition, in a changed implementation, one or two of the distal retention surface 121, the corner retention surface 122, and the gingival retention surface 123 may alternatively be set as extending away from the bottom surface 11 along a straight line (as shown in this embodiment or shown in any one of the embodiments of FIG. 20a to FIG. 24b), and the remaining is set as extending away from the bottom surface 11 along a curved line (as shown in the embodiment shown in FIG. 25a). None of these changes departs from the technical aim of this application.

Specifically, in this embodiment, referring to FIG. 18b and FIG. 18c, each of the distal retention surface 121, the corner retention surface 122, and the gingival retention surface 123 is perpendicular to the bottom surface 11 (that is, parallel to the normal direction of the bottom surface 11). As shown in FIG. 18c, the angle k1 is a right angle, that is, each of the corner retention surface 122, and the gingival retention surface 123 extends along a straight line perpendicular to the bottom surface 11. Therefore, it may be learned with reference to the above descriptions that, each of the distal retention surface 121 and the gingival retention surface 123 is a plane perpendicular to the bottom surface 11, and the corner retention surface 122 is a cylindrical arc surface perpendicular to the bottom surface 11.

In addition, in this embodiment, the retention attachment 10 may further include a skid-proof structure added to the retention surface 12, where the skid-proof structure may be specifically any one of or a combination of a plurality of bumps, a plurality of dents, and one or more nicks, to enhance a friction force between the retention attachment 10 and the orthodontic appliance and ensure the retention effect on the orthodontic appliance.

Further, the non-retention surface 13 has no retention effect on the orthodontic appliance 200′ on the dentition 100′, and has a more gentle relationship with the bottom surface 11 compared with the relationship between the retention surface 12 and the bottom surface 11, and the configuration of the non-retention surface 13 helps guide the orthodontic appliance 200′ to be in place smoothly, for example, guide an accommodating groove 200e′ of the orthodontic appliance 200′ to be smoothly stuck at the retention attachment 10 in the following description. Therefore, the non-retention surface 13 may also be referred to as a guiding surface.

The non-retention surface 13 extends obliquely downward from the upper edge 12a of the retention surface 12, until connecting to the edge P1-P4 of the bottom surface 11 (that is, a part remaining after the edge P1-P2-P3-P4 is excluded from the peripheral edge of the bottom surface 11). Preferably, the non-retention surface 13 is set as a convex curved surface, and an angle k2 between a tangent plane in any position on the non-retention surface 13 and the bottom surface 11 is smaller than 60°.

Further, corresponding to the construction method shown in FIG. 12, an embodiment further provides a construction system for a retention attachment.

The construction system includes a memory and a processor, where the memory stores a computer program runnable on the processor, and when the processor executes the computer program, the steps of the construction method described above are implemented.

With reference to FIG. 12 to FIG. 16, the processor of the construction system is briefly described. The processor includes an obtaining unit, a control unit, and a processing unit.

The obtaining unit is configured to obtain a dentition model 100 and a shell-shaped orthodontic appliance model 200 matching the dentition model 100; the control unit is configured to control the shell-shaped orthodontic appliance model 200 worn on the dentition model 100 to be removed from the dentition model 100; when the shell-shaped orthodontic appliance model 200 worn on the dentition model 100 is removed from the dentition model 100, the obtaining unit is further configured to obtain a moving track R of a reference position P02 on the shell-shaped orthodontic appliance model 200 that corresponds to the mounting position P01; the processing unit is configured to establish a tangent line (such as the tangent line Q1, Q2, or Q3 shown in FIG. 16) of a key position in the moving track R or establish a direct connection line (such as the direct connection line Q4 or Q5 shown in FIG. 16) between two key positions in the moving track R, and construct the retention attachment 10 according to the rules.

It should be noted that the units of the processor may be further configured to perform specific implementations of corresponding steps in the foregoing construction method and other steps. For details, reference may be made to the foregoing descriptions, and details are not described again herein.

Further, corresponding to the construction method shown in FIG. 12 to FIG. 16, an embodiment further provides a computer-readable storage medium storing a computer program, wherein when the computer program is executed by a processor, the steps of the construction method described above are implemented. Details are not described again.

The invisible orthodontic appliance of the embodiments is described in detail below with reference to the above descriptions, and FIG. 17 to FIG. 19b.

The invisible orthodontic appliance includes a shell-shaped orthodontic appliance 200′ and the foregoing retention attachment 10.

It can be understood that the structure or structural style of the orthodontic appliance 200′ substantially corresponds to that of the shell-shaped orthodontic appliance model 200 in the construction method, and only an accommodating groove 200e′ is additionally provided based on the shell-shaped orthodontic appliance model 200.

The retention attachment 10 is constructed with the foregoing construction method, and the bottom surface 11 of the retention attachment is fixedly mounted on a tooth surface on the dentition 100′, to provide a retention force for the orthodontic appliance 200′ adapting to the dentition 100′. In a specific implementation, the bottom surface 11 may be fixed on the surface of the tooth in a sticking manner.

The inner cavity of the orthodontic appliance 200′ may accommodate the dentition 100′. It may be understood that, the orthodontic appliance 200′ is divided into shell units adapting to structural styles of teeth on the dentition 100′ one by one. For example, corresponding to a last molar (that is, the following second molar 100a′), the orthodontic appliance 200′ includes a shell unit 200a′, and an inner cavity of the shell unit 200a′ may just accommodate the last molar 100a′.

The orthodontic appliance 200′ further includes an attachment accommodating groove 200e′, and the attachment accommodating groove 200e′ is in communication with the inner cavity of the orthodontic appliance 200′ and may accommodate the retention attachment 10. When the orthodontic appliance 200′ is mounted onto the dentition 100′, the non-retention surface 13 of the retention attachment 10 helps guide the orthodontic appliance 200′ to be in place smoothly, so that the attachment accommodating groove 200e′ of the orthodontic appliance 200′ is smoothly stuck at the retention attachment 10, that is, the retention attachment 10 is embedded in the attachment accommodating groove 200e′. When the appliance 200′ is maintained on the dentition 100′, that is, is in a mounting completed state, the retention surface 12 of the retention attachment 10 may butt against a groove surface of the attachment accommodating groove 200e′, to prevent the orthodontic appliance 200′ from separating from the dentition 100′.

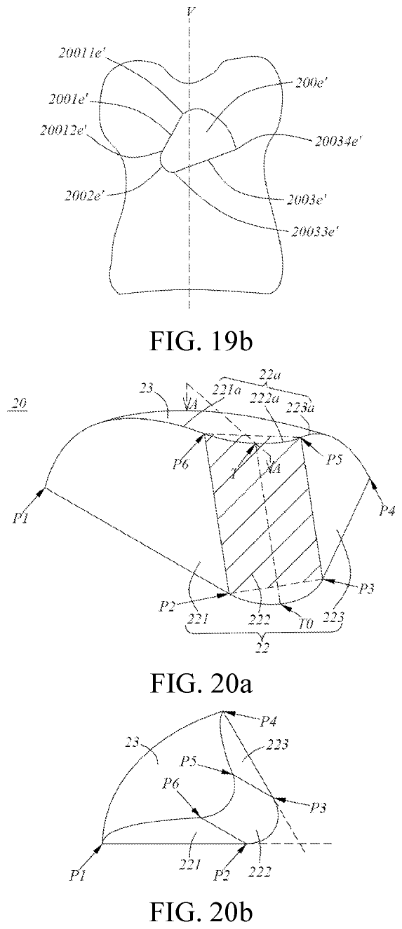

Referring to FIG. 19a and FIG. 19b, the gingival retention surface 123 of the retention surface 12 butts against a gingival groove surface 2003e′ of the accommodating groove 200e′, and the gingival groove surface 2003e′ is a groove surface of the accommodating groove 200e′ that is close to a gingival side; the distal retention surface 121 of the retention surface 12 butts against a distal groove surface 2001e′ of the accommodating groove 200e′, and the distal groove surface 2001e′ is a groove surface of the accommodating groove 200e′ that is close to a distal side; and the corner retention surface 122 of the retention surface 12 butts against a corner groove surface 2002e′ of the accommodating groove 200e′, and two ends of the corner groove surface 2002e′ are connected to the gingival groove surface 2003e′ and the distal groove surface 2001e′. It may be learned through the foregoing construction method that, the bottom surface 11 of the retention attachment 10 matches the surface of the tooth 100a′ on which the retention attachment 10 is mounted, and the gingival retention surface 123 is at an angle ranging from 60° to 90° with the first auxiliary line (such as the tangent line Q1, Q2, or Q3 shown in FIG. 16) or the direct connection line (such as the direct connection line Q4 shown in FIG. 16). Therefore, in an embodiment of this application, in contrast to the existing technology, the retention force of the retention attachment 10 for the orthodontic appliance 200′ is greatly increased, to resolve the problem in the existing technology that an orthodontic appliance is prone to fall off because a retention attachment has an insufficient retention force for the orthodontic appliance.

Further, the orthodontic appliance 200′ includes a labial-buccal shell 200d′ and a lingual shell 200c′. When the orthodontic appliance 200′ is mounted onto the dentition 100′, the labial-buccal shell 200d′ is located on a labial-buccal side of the dentition 100′, and the lingual shell 200c′ is located on a lingual side of the dentition 100′.

Attachment accommodating grooves 200e′ are disposed in the labial-buccal shell 200d′ and located in any one or more of a plurality of shell units of the orthodontic appliance 200′ that correspond to molars and premolars. For example, the orthodontic appliance 200′ shown in FIG. 17 includes a shell unit 200b′ corresponding to a first molar 100b′ (for ease of understanding, subsequently referred to as a “first molar shell unit 200b′”), a shell unit 200a′ corresponding to a second molar 100a′ (for ease of understanding, subsequently referred to as a “second molar shell unit 200a′”), a shell unit corresponding to a first premolar (for ease of understanding, subsequently referred to as a “first premolar shell unit”), and a shell unit corresponding to a second premolar (for ease of understanding, subsequently referred to as a “second premolar shell unit”). Any one of or any two or more of the first molar shell unit 200b′, the second molar shell unit 200a′, the first premolar shell unit, and the second premolar shell unit are provided with attachment accommodating grooves 200e′. It may be understood that, corresponding teeth are also equipped with retention attachments 10 matching the attachment accommodating grooves 200e′. Certainly, in a changed implementation, for a dentition including a third molar, the orthodontic appliance 200′ correspondingly includes a third molar shell unit corresponding to the third molar, and an attachment accommodating grooves 200e′ may also be located in the third molar shell unit.

Preferably, as shown in FIG. 17, the attachment accommodating grooves 200e′ is located in a shell unit 200a′ of the orthodontic appliance 200′, which corresponds to a last molar (such as the second molar 100a′ in FIG. 17). That is to say, referring to FIG. 17, the attachment accommodating grooves 200e′ is disposed on a labial-buccal side of the shell unit 200a′, and is more preferably located in a middle area of the labial-buccal side of the shell unit 200a′. It can be understood that corresponding to the position of the attachment accommodating groove 200e′, the retention attachment 10 is similarly mounted on a labial-buccal surface of the last molar (such as the second molar 100a′ in FIG. 17) of the dentition 100′. Therefore, for a case mentioned in the background that the retention attachment attaches to the labial-buccal surface of the tooth, the retention effect of the retention attachment 10 on the orthodontic appliance 200′ is greatly improved, to prevent the orthodontic appliance 200′ from accidentally falling off when a behavior of the patient such as licking or pressing of the tongue occurs unconsciously.

Furthermore, preferably, the attachment accommodating groove 200e′ may alternatively be located in a shell unit 200b′ of the orthodontic appliance 200′, which corresponds to a second-to-last tooth (such as the first molar 100b′ in FIG. 17). That is to say, referring to FIG. 17, the attachment accommodating grooves 200e′ is disposed on a labial-buccal side of the shell unit 200b′, and is more preferably located in a distal area of the labial-buccal side of the shell unit 200b′.

In addition, based on a correspondence between the dentition model 100 and the dentition 100′:
with reference to the foregoing orientation relationship between the direct connection line between the point P1 and the point P2 and the long axis of the tooth 100a on which the attachment mounting selectable area A1 is located, it may be determined that referring to FIG. 19a, on the projection surface in the normal direction of the bottom surface 11, the direct connection line between the point P1 and the point P2 is at an angle ranging from 0° to 45°
with the long axis V1 of the tooth (such as 100a′ or 100b′ shown in FIG. 17) on which the retention attachment 10 is located; and with reference to the foregoing orientation relationship between the direct connection line between the point P3 and the point P4 and the long axis of the tooth 100a on which the attachment mounting selectable area A1 is located, it may be determined that referring to FIG. 19a, on the projection surface in the normal direction of the bottom surface 11, the direct connection line between the point P3 and the point P4 is at an angle ranging from 60° to 90° with the long axis V1 of the tooth (such as 100a′ or 100b′ shown in FIG. 17) on which the retention attachment 10 is located.

Further, the distal groove surface 2001e′ of the accommodating groove 200e′ is in a shape matching the intersection line P1-P2 of the distal retention surface 121 and the bottom surface 11. Then, referring to FIG. 19b, on the projection surface in the normal direction of the bottom surface 11, a direct connection line between two endpoints 20012e′ and 20011e′ of the distal groove surface 2001e′ is at an angle ranging from 0° to 45° with the long axis V of the shell unit (such as 200a′ or 200b′ shown in FIG. 17) on which the accommodating groove 200e′ is located. In this embodiment, the distal groove surface 2001e′ extends in a straight line from the endpoint 20012e′ to the endpoint 20011e′.

Similarly, the gingival groove surface 2003e′ of the accommodating groove 200e′ is in a shape matching the intersection line P3-P4 of the gingival retention surface 123 and the bottom surface 11. Then, referring to FIG. 19b, on the projection surface in the normal direction of the bottom surface 11, a direct connection line between two endpoints 20033e′ and 20034e′ of the gingival groove surface 2003e′ is at an angle ranging from 60° to 90° with the long axis V of the shell unit (such as 200a′ or 200b′ shown in FIG. 17) on which the accommodating groove 200e′ is located. In this embodiment, the gingival groove surface 2003e′ extends in a straight line from the endpoint 20033e′ to the endpoint 20034e′.

In addition, the corner groove surface 2002e′ of the accommodating groove 200e′ is in a shape matching the intersection line P3-P2 of the corner retention surface 122 and the bottom surface 11, and is in a shape of a circular arc in this embodiment.

Based on the above, this embodiment has the following beneficial effects:
(1) The bottom surface 11 is constructed based on the attachment mounting selectable area A1, and the gingival retention surface 123 is constructed based on the first auxiliary line, so that the retention attachment 10 can greatly increase a retention force for an orthodontic appliance 200′, to resolve the problem in the existing technology that an orthodontic appliance is prone to fall off because a retention attachment has an insufficient retention force for the orthodontic appliance.
(2) The acting area of the actuating force is selected on the lingual side of the shell-shaped orthodontic appliance model 200, and the removing process of the shell-shaped orthodontic appliance model 200 is implemented based on this, so that the constructed retention attachment 10 can improve the retention effect during lingual fall-off, that is, prevent the orthodontic appliance from accidentally falling off when an incentive such as unconsciously licking or pressing of the tongue of the patient occurs.
(3) In addition, the corner retention surface 122 is constructed based on the second auxiliary line, and a series of design solutions such as the design of an angle relationship between each retention surface and the bottom surface 11 and the design of an angle relationship between the intersection line P1-P2 on the distal retention surface 121 and the intersection line P3-P4 on the gingival retention surface 123 further optimize the structure of the retention attachment 10 and/or optimize a layout orientation of the retention attachment 10 on a tooth, to ensure a sufficient retention effect on the orthodontic appliance and provide a more obvious retention advantage compared with the existing attachment particularly for a patient with a short dental crown, for example, a young patient.

### Embodiment 12

Referring to FIG. 20a to FIG. 20c, a preferred embodiment 12 of this application is shown. An only difference between this embodiment and the foregoing embodiment 11 is: an angle between each of a distal retention surface 221, a corner retention surface 222, and a gingival retention surface 223 and the bottom surface 21 is different from that shown in FIG. 18a in the embodiment 11. Only technical content related to the difference is described below, and the remaining technical content the same as that in the embodiment 11 is not described again in detail.

As shown in FIG. 18a in the foregoing embodiment 11, each of the distal retention surface 121, the corner retention surface 122, and the gingival retention surface 123 is perpendicular to the bottom surface 11, that is, the angle k1 between the retention surface 12 and the bottom surface 11 is 90°.

However, in this embodiment 12, the angle between each of the distal retention surface 221, the corner retention surface 222, and the gingival retention surface 223 and the bottom surface 21 is an acute angle greater than or equal to 60°. From a different perspective, each of the distal retention surface 221, the corner retention surface 222, and the gingival retention surface 223 extends along a straight line at an acute angle greater than or equal to 60° with the bottom surface 21. Therefore, this embodiment is specifically the same as the embodiment 11 in that, each of the distal retention surface 221 and the gingival retention surface 223 is a plane, and the corner retention surface 122 is a cylindrical arc surface.

Embodiments 13 to 16 First, referring to FIG. 21a and FIG. 21b, a preferred embodiment 13 of this application is shown. An only difference between this embodiment and the foregoing embodiment 11 is: configurations of a distal retention surface 521 and a gingival retention surface 523. Only technical content related to the difference is described below, and the remaining technical content the same as that in the embodiment 11 is not described again in detail.

In the foregoing embodiment 11, each of the distal retention surface 121 and the gingival retention surface 123 is a plane; and each of the intersection line P1-P2 of the distal retention surface 121 and the bottom surface 11 and the intersection line P3-P4 of the gingival retention surface 123 and the bottom surface 11 is a straight line.

However, in this embodiment 13, referring to FIG. 21a and FIG. 21b, each of the distal retention surface 521 and the gingival retention surface 523 is designed into a concave curved surface.

Specifically, an intersection line P2-P6 of the distal retention surface 521 and the corner retention surface 522 is a straight line, and an intersection line P1-P2 of the distal retention surface 521 and a bottom surface 51 is a concave curved line. Therefore, the distal retention surface 521 is designed into a concave curved surface extending perpendicular to the bottom surface 51 from the intersection line P1-P2.

Similarly, an intersection line P3-P5 of the gingival retention surface 532 and the corner retention surface 522 is a straight line, and an intersection line P3-P4 of the gingival retention surface 532 and the bottom surface 51 is a concave curved line. Therefore, the gingival retention surface 532 is constructed based on the rule 2, a plane S1 defined by the intersection line P3-P5 and a point P4 is at an angle ranging from 60° to 90° with the first auxiliary line, and based on this, the gingival retention surface 532 is designed into a concave curved surface extending perpendicular to the bottom surface 51 from the intersection line P3-P4.

Certainly, in the foregoing embodiment 13, the intersection line P1-P2 of the distal retention surface 521 and the bottom surface 51 is a concave curved line, and the intersection line P3-P4 of the gingival retention surface 532 and the bottom surface 51 is a concave curved line. This application is not limited thereto. For example, an embodiment 14 shown in FIG. 22a and FIG. 22b is changed based on the embodiment 13 as follows: The intersection line P1-P2 of the distal retention surface 621 and the bottom surface 61 is a convex curved line. For another example, an embodiment 15 shown in FIG. 23a and FIG. 23b is changed based on the embodiment 13 as follows: Each of the intersection line P1-P2 of the distal retention surface 721 and the bottom surface 71 and the intersection line P3-P4 of the gingival retention surface 732 and the bottom surface 71 is a convex curved line. For another example, an embodiment 16 shown in FIG. 24a and FIG. 24b is changed based on the embodiment 13 as follows: The intersection line P3-P4 of the gingival retention surface 832 and the bottom surface 81 is a convex curved line.

Certainly, each distal retention surface and each gingival retention surface in the embodiments 13 to 16 extend, for example, perpendicular to the bottom surface. In a changed implementation, each distal retention surface and each gingival retention surface may be changed and designed into being arranged at any other angle ranging from 60° to 120° with the bottom surface, that is, each distal retention surface and each gingival retention surface may extend along a straight line at an angle ranging from 60° to 120° with the bottom surface.

### Embodiment 17

Referring to FIG. 25a to FIG. 25c, a preferred embodiment 17 of this application is shown. An only difference between this embodiment and the foregoing embodiment 11 is: configurations of a distal retention surface 1121, a corner retention surface 1122 and a gingival retention surface 1123 of a retention surface112. Only technical content related to the difference is described below, and the remaining technical content the same as that in the embodiment 11 is not described again in detail.

As mentioned in the foregoing embodiment 11, each of the distal retention surface 121, the corner retention surface 122, and the gingival retention surface 123 may be set as: being arranged at an angle ranging from 60° to 120° with the bottom surface 11. From a different perspective, each of the distal retention surface 121, the corner retention surface 122, and the gingival retention surface 123 extends along a straight line at an angle ranging from 60° to 120° with the bottom surface 11.

However, in this embodiment 17, referring to FIG. 25a and FIG. 25c, each of the distal retention surface 1121, the corner retention surface 1122, and the gingival retention surface 1123 is set as: extending away from a bottom surface 111 in a concave curved shape from an intersection line of the retention surface 112 and the bottom surface 111, until reaching an upper edge 112a of the retention surface 112.

Specifically, the intersection line P3-P4 of the gingival retention surface 1123 and the bottom surface 111 is a straight line, the gingival retention surface 1132 is constructed based on the rule 2, a plane S1 defined by the intersection line P3-P4 and a point P5 is at an angle ranging from 60° to 90° with the first auxiliary line, and based on this, the gingival retention surface 1132 is designed into a concave curved surface extending away from the bottom surface 111 in a concave curved shape from the intersection line P3-P4.

In addition, further, the plane S1 defined by the intersection line P3-P4 and the point P5 is further set as: being arranged at an angle ranging from 60° to 120° with the bottom surface 111. The angle may preferably range from 60° to 90°, and more preferably range from 75° to 90°. In the accompanying drawing, the angle is, for example, an angle 90° (that is, a direct connection line between the point P5 and the point P3 is perpendicular to the bottom surface 111).

Further, the intersection line P2-P1 of the distal retention surface 1121 and the bottom surface 111 is a straight line, and the distal retention surface 1121 is designed into a concave curved surface extending away from the bottom surface 111 in a concave curved shape from the intersection line P2-P1. In addition, the plane defined by the intersection line P2-P1 and the point P6 is further set as: being arranged at an angle ranging from 60° to 120° with the bottom surface 111. The angle may preferably range from 60° to 90°, and more preferably range from 75° to 90°. In the accompanying drawing, the angle is, for example, an angle 90° (that is, a direct connection line between the point P6 and the point P2 is perpendicular to the bottom surface 111).

In addition, similarly, the corner retention surface 1122 is designed into: extending away from the bottom surface 111 in a concave curved shape from an intersection line P2-P3 of the corner retention surface and the bottom surface 111. In addition, the plane S2 defined by the point P2, the point P3, and the point P5 is set as: being arranged at an angle ranging from 60° to 120° with the bottom surface 111. The angle may preferably range from 60° to 90°, and more preferably range from 75° to 90°. In the accompanying drawing, the angle is, for example, an angle 90°.

It should be additionally noted that although the retention attachments shown in the embodiments shown in FIG. 20a to FIG. 25c is slightly different from that shown in the embodiment 11, each of the retention attachments may be constructed and molded with the construction method and the construction system disclosed in the embodiment 11 and may also be used for performing retention on the orthodontic appliance adapting to each retention attachment. The specific structure of the orthodontic appliance adapting to each retention attachment is correspondingly changed based on the embodiment 11. Details are not described again.

### Embodiment 18

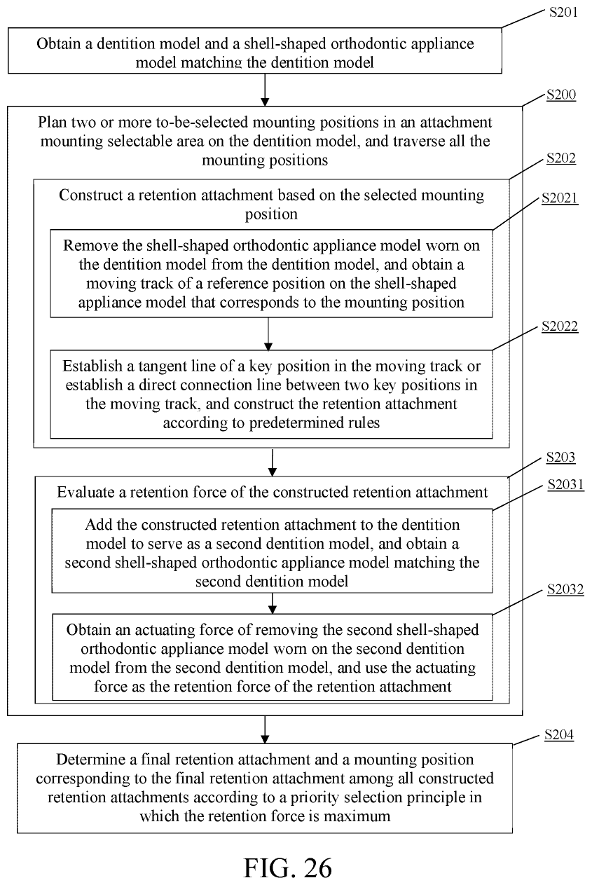

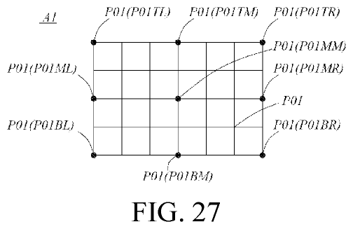

Next, referring to FIG. 26 and FIG. 27, another embodiment of a construction method for a retention attachment in this application is shown. In this embodiment, the construction method includes the following steps.

Step S201. obtain a dentition model and a shell-shaped orthodontic appliance model matching the dentition model; and

Step S202. Select a mounting position from an attachment mounting selectable area on the dentition model, and construct a retention attachment based on the mounting position.

The steps S201 and S202 in this embodiment respectively correspond to the steps S101 and S102 in the embodiment shown in FIG. 12, a specific implementation of each step (including sub-steps) in this embodiment is the same as that in the embodiment in FIG. 12, understanding may be made with reference to the above descriptions, and details are not described again.

A difference between the embodiment in FIG. 26 and the embodiment in FIG. 12 is described below. Specifically, in the foregoing embodiment in FIG. 12, a retention attachment is constructed based on a mounting position P01. In the embodiment shown in FIG. 26, respective corresponding retention attachments are constructed based on two or more mounting positions POT respectively, and an optimal choice is made from the retention attachments.

Specifically, as shown in FIG. 26, in another embodiment, the construction method further includes the following steps.

Step S200. Plan two or more to-be-selected mounting positions in an attachment mounting selectable area on the dentition model, and select each mounting position sequentially, to sequentially perform the following on each mounting position:
the step S202 of “select a mounting position from an attachment mounting selectable area on the dentition model, and construct a retention attachment based on the mounting position”; in other words, the step S202 is construct a retention attachment based on the selected mounting position; and
a step S203, evaluate a retention force of the constructed retention attachment.

Understanding is made based on the step S200, with reference to FIG. 27, and with reference to FIG. 13. At least two mounting positions P01 are planned in the attachment mounting selectable area A1 on the dentition model 100, and step S202 and step S203 are performed based on each mounting position P01. Therefore, retention attachments in a one-to-one correspondence with all the mounting positions P01 are constructed, and retention forces of all the constructed retention attachments are evaluated, to make an optimal choice subsequently (as described in the following step S204).

Preferably, in the step 200, referring to FIG. 27, the “plan two or more to-be-selected mounting positions in the attachment mounting selectable area on the dentition model” may be specifically implemented as follows: A plurality of nodes distributed in a row-column matrix are planned in the attachment mounting selectable area A1, and all or part of the nodes are used as the to-be-selected mounting positions, so that to plan all the to-be-selected mounting positions.

Further, preferably, all the to-be-selected mounting positions include two or more of an internal center point P01MM, a mesial edge center point P01MR, a mesial edge occlusion endpoint P01TR, a mesial edge gingiva endpoint P01BR, a distal edge center point P01ML, a distal edge occlusion endpoint P01TL, a distal edge gingiva endpoint P01BL, an occlusion edge center point P01TM, and a gingiva edge center point P01BM of the attachment mounting selectable area A1. For example, the mentioned nine mounting positions P01 are used as all the to-be-selected mounting positions. Then, through the traversal process of the step 200 and based on step S202 and step S203, nine retention attachments in a one-to-one correspondence with the mentioned nine mounting positions P01 are constructed, and respective retention forces of the nine retention attachments are evaluated.

As described above, the step S202 is the same as the step S102 in the embodiment in FIG. 12. Details are not described again. Next, step S203 is described.

In the step S203, the “retention force of the retention attachment” is a retention force of the retention attachment for the shell-shaped orthodontic appliance adapting to the retention attachment. In a preferred implementation, the step S203 includes the following sub-steps.

Sub-step S2031. Add the constructed retention attachment to the dentition model to serve as a second dentition model, and obtain a second shell-shaped orthodontic appliance model matching the second dentition model.

In the sub-step, comparing with the dentition model obtained in step S201, the only difference between the second dentition model and the dentition model obtained in step S201 is that the retention attachment constructed in step S202 is added to the second dentition model. In addition, it can be understood that the position of the retention attachment on the second dentition model is fixed at the mounting position P01 corresponding to the retention attachment. For example, in step S202, for the retention attachment constructed based on the internal center point P01MM in FIG. 27, correspondingly in step S203, the retention attachment is located at the internal center point P01MM on the second dentition model, and particularly the retention surface of the retention attachment is located at the internal center point P01MM. Except this difference, the second dentition model is the same as the dentition model in step S201, and the second dentition model is not described in detail again.

In addition, it can be similarly understood that the second shell-shaped orthodontic appliance model matches the second dentition model. To be specific, by comparing the second shell-shaped appliance model with the shell-shaped orthodontic appliance model obtained in step S201, only an attachment accommodating groove is added to match a retention attachment on the second dentition model.

Sub-step S2032. obtain an actuating force of removing the second shell-shaped orthodontic appliance model worn on the second dentition model from the second dentition model, and use the actuating force as the retention force of the retention attachment.

First, the second shell-shaped orthodontic appliance model is worn on the second dentition model, and then an actuating force is applied to the second shell-shaped orthodontic appliance model, so that the second shell-shaped orthodontic appliance model can be removed from the second dentition model, and the actuating force is used as the retention force of the retention attachment. The magnitude of the actuating force may substantially reflect the retention effect of the retention attachment on the matching shell-shaped orthodontic appliance.

Further, the acting area and the direction of the actuating force in the “obtain an actuating force of removing the second shell-shaped orthodontic appliance model worn on the second dentition model from the second dentition model” in sub-step S2032 are completely the same as those in the “remove the shell-shaped orthodontic appliance model worn on the dentition model from the dentition model” in sub-step S2021. For example, as described above, the acting area of the actuating force is selected on the lingual side of the shell-shaped orthodontic appliance model 200. For another example, as described above, the actuating force is in a direction of being at a non-zero angle with the long axis of the tooth on which the attachment mounting selectable area is located, pointing to the occlusion end from the gingiva end, and pointing to the lingual side from the labial-buccal side. For details, refer to the above descriptions. Details are not described again.

Step S204. determine a final retention attachment and a mounting position corresponding to the final retention attachment among all constructed retention attachments according to a priority selection principle in which the retention force is maximum.

It can be understood with reference to the above descriptions that a larger retention force of the retention attachment indicates a better retention effect of the retention attachment on the matching shell-shaped orthodontic appliance when the retention attachment is mounted at the mounting position P01 corresponding to the retention attachment. Therefore, by traversing all the mounting positions POT and comparing magnitudes of retention forces of the retention attachments constructed based on the mounting positions POT, a retention attachment with an optimal retention effect and a mounting position P01 corresponding to the retention attachment may be selected. For example, through step S204, the retention attachment constructed based on the internal center point P01MM and selected from the nine retention attachments respectively constructed based on the nine mounting positions POT in FIG. 27 has a maximum retention force. Therefore, for the dentition at which the dentition model is targeted, in the designed invisible orthodontic appliance, the configuration of the retention attachment is that of the retention attachment constructed based on the internal center point P01MM, and the retention attachment is mounted on a tooth surface on the dentition that corresponds to the internal center point P01MM. Correspondingly, the position on the shell-shaped orthodontic appliance that corresponds to the internal center point P01MM is provided with an attachment accommodating groove.

It may be learned from the above descriptions that, in addition to the beneficial effects of FIG. 12, the embodiment shown in FIG. 26 can further improve, by optimally selecting a retention attachment and a mounting position of the retention attachment based on the embodiment shown in FIG. 12, the retention effect of the involved retention attachment on the shell-shaped orthodontic appliance, and further reduce the probability that the shell-shaped orthodontic appliance accidentally falls off.

Further, corresponding to the construction method of the embodiment shown in FIG. 26, another embodiment of this application further provides a construction system for a retention attachment.

The construction system includes a memory and a processor, where the memory stores a computer program runnable on the processor, and when the processor executes the computer program, the steps of the construction method described above are implemented.

Similar to the foregoing processor of the construction system corresponding to FIG. 12, the processor of this embodiment also includes an obtaining unit, a control unit, and a processing unit. In addition, corresponding to the construction method of the embodiment shown in FIG. 26, the processor in this embodiment further includes a traversing unit and a screening unit.

The obtaining unit is configured to obtain a dentition model and a shell-shaped orthodontic appliance model matching the dentition model;
the traversing unit is configured to plan two or more to-be-selected mounting positions in the attachment mounting selectable area on the dentition model, and traverse all the mounting points;
the control unit is configured to control the shell-shaped appliance model worn on the dentition model to be removed from the dentition model;
when the shell-shaped orthodontic appliance model worn on the dentition model is removed from the dentition model, the obtaining unit is further configured to obtain a moving track of a reference position on the shell-shaped orthodontic appliance model that corresponds to the mounting position selected by the traversing unit;
the processing unit is configured to establish a tangent line of a key position in the moving track or establish a direct connection line between two key positions in the moving track, and construct the retention attachment according to the rules;
the obtaining unit is further configured to add the constructed retention attachment to the dentition model to serve as a second dentition model, and obtain a second shell-shaped orthodontic appliance model matching the second dentition model; and obtain an actuating force of removing the second shell-shaped orthodontic appliance model worn on the second dentition model from the second dentition model, and use the actuating force as a retention force of the retention attachment on the second dentition model; and
the screening unit is configured to determine a final retention attachment and a mounting position corresponding to the final retention attachment among all constructed retention attachments according to a priority selection principle in which the retention force is maximum.

It should be noted that the units of the processor may be further configured to perform specific implementations of corresponding steps in the construction method and other steps. For details, reference may be made to the foregoing descriptions.

Further, corresponding to the construction method of the embodiment shown in FIG. 26, another embodiment of this application further provides a computer-readable storage medium, storing a computer program, where when the computer program is executed by a processor, the steps of the construction method described above are implemented.

In addition, another embodiment of this application further provides an invisible orthodontic appliance. A retention attachment of the invisible orthodontic appliance is constructed with the construction method shown in FIG. 26. For the rest, reference may be made to the previous embodiment, and details are not described again.

In addition, each retention attachment shown in the foregoing embodiments 11 to 18 may be constructed, molded, and fixed through the construction method and the construction system of the embodiments.

Generally, compared with the prior art, this application has the following beneficial effects: The retention force of the retention attachment for the orthodontic appliance can be increased, to resolve the problem in the existing technology that an orthodontic appliance is prone to fall off because a retention attachment has an insufficient retention force for the orthodontic appliance. In addition, further, based on the positions of the attachment mounting selectable area, the acting area of the actuating force, and the like, a case that the orthodontic appliance falls off because of licking or pressing of the tongue can be further avoided, to greatly improve the retention effect on the orthodontic appliance.

It should be understood that, although this specification is described according to the embodiments, each embodiment may not include only one independent technical solution. The description manner of this specification is merely for clarity. This specification should be considered as a whole by a person skilled in the art, and the technical solution in each embodiment may also be properly combined, to form other implementations that can be understood by the person skilled in the art.

The detailed descriptions listed above are specific descriptions for only feasible embodiments of this application, and are not intended to limit the protection scope of this application. Any equivalent embodiment or change made without departing from the skill and spirit of this application should be included in the protection scope of this application.

1. An attachment for invisible orthodontic appliance without bracket, comprising a bottom surface for attaching to a tooth, a retention surface extending upward from a partial edge of the bottom surface, and a non-retention surface connecting an upper edge of the retention surface to the remaining edge of the bottom surface, wherein the retention surface and the bottom surface are arranged at an angle ranging from 60° to 120°, the upper edge of the retention surface defines a maximum height of the attachment in a normal direction of the bottom surface, and the retention surface comprises a first retention area, a second retention area, and a third retention area sequentially connected along the partial edge of the bottom surface; the second retention area is arc-shaped on a cross-section perpendicular to a normal of the bottom surface; and an angle between the first retention area and the third retention area ranges from 60° to 120°.

2. The attachment for invisible orthodontic appliance without bracket of claim 1, wherein an upper edge of the second retention area defines the maximum height of the attachment in the normal direction of the bottom surface.

3. The attachment for invisible orthodontic appliance without bracket of claim 1, wherein the non-retention surface is set as a convex curved surface, and an angle between a tangent plane in any position on the non-retention surface and the bottom surface is smaller than an angle between the retention surface and the bottom surface.

4. The attachment for invisible orthodontic appliance without bracket of claim 1, wherein on the cross-section perpendicular to the normal of the bottom surface, the second retention area is in a shape of a circular arc or in a shape of an elliptic arc with a convex middle portion.

5. The attachment for invisible orthodontic appliance without bracket of claim 1, wherein the retention surface and the bottom surface are arranged at an angle ranging from 60° to 90°.

6. The attachment for invisible orthodontic appliance without bracket of claim 1, wherein the retention surface and the bottom surface are arranged at an angle ranging from 75° to 90°.

7. The attachment for invisible orthodontic appliance without bracket of claim 1, wherein on the cross-section perpendicular to the normal of the bottom surface, each of the first retention area and the third retention area is any one of a straight line, a concave curved line, or a convex curved line.

8. The attachment for invisible orthodontic appliance without bracket of claim 1, wherein the first retention area and the third retention area are set as planes.

9. The attachment for invisible orthodontic appliance without bracket of claim 1, wherein each of the first retention area, the second retention area, and the third retention area is set as: a part in a straight-line curved surface having a straight line perpendicular to the bottom surface as a generatrix, having an edge of the bottom surface as a guiding line, and having each profile line perpendicular to the bottom surface.

10. The attachment for invisible orthodontic appliance without bracket of claim 1, wherein each of the first retention area, the second retention area, and the third retention area is set as: a part in a straight-line curved surface having a straight line at an acute angle greater than or equal to 60° with the bottom surface as a generatrix and having an edge of the bottom surface as a guiding line.

11. The attachment for invisible orthodontic appliance without bracket of claim 1, wherein each of the first retention area, the second retention area, and the third retention area is set as: being perpendicular to the bottom surface and extending upward along a straight line.

12. The attachment for invisible orthodontic appliance without bracket of claim 1, wherein each of the first retention area, the second retention area, and the third retention area is set as: being at an acute angle greater than or equal to 60° with the bottom surface and extending upward along a straight line.

13. The attachment for invisible orthodontic appliance without bracket of claim 1, wherein each of the first retention area, the second retention area, and the third retention area is set as: extending upward in a convex or concave curved shape, and a plane constructed by a higher endpoint of an upper edge of each retention area and two endpoints on edges of the bottom surface defines an angle between each retention area and the bottom surface.

14. The attachment for invisible orthodontic appliance without bracket of claim 1, wherein on the partial edge of the bottom surface, an angle between a connection line between two farthest endpoints of the first retention area and a connection line between two farthest endpoints of the third retention area defines an angle between the first retention area and the third retention area.

15. The attachment for invisible orthodontic appliance without bracket of claim 1, further comprising a skid-proof structure added to the retention surface, wherein the skid-proof structure is any one of or a combination of a plurality of bumps, a plurality of dents, and one or more nicks.

16. An attachment for invisible orthodontic appliance without bracket, comprising a bottom surface for attaching to a tooth, a retention surface extending upward from a partial edge of the bottom surface, and a non-retention surface extending obliquely downward from an upper edge of the retention surface to the remaining edge of the bottom surface, wherein the non-retention surface is set as a convex curved surface, an angle between a tangent plane in any position on the non-retention surface and the bottom surface is smaller than an angle between the retention surface and the bottom surface, and the retention surface comprises a first retention area, a second retention area, and a third retention area sequentially connected along the partial edge of the bottom surface; the second retention area is arc-shaped on a cross-section perpendicular to a normal of the bottom surface; and an angle between the first retention area and the third retention area ranges from 60° to 120°.

17. An invisible orthodontic device combination, comprising a shell-shaped orthodontic appliance, wherein the shell-shaped orthodontic appliance defines an inner cavity capable of accommodating a dentition; and the orthodontic device combination further comprises the attachment of claim 1, the shell-shaped orthodontic appliance further comprises an accommodating groove in communication with the inner cavity and capable of accommodating the attachment, and the retention surface butts against a groove surface of the accommodating groove to prevent the orthodontic appliance from separating from the dentition.

18. The invisible orthodontic device combination of claim 17, wherein the first retention area butts against a distal groove surface of the accommodating groove, and the third retention area butts against a gingival groove surface of the accommodating groove.

19. The invisible orthodontic device combination of claim 18, wherein the distal groove surface is at an angle ranging from 45° to 90° with a vertical surface of a long axis of a shell unit in which the accommodating groove is located in an extending direction from a gingiva end of the distal groove surface to an occlusion end of the distal groove surface; and the gingival groove surface is at an angle ranging from 0° to 30° with the vertical surface of the long axis of the shell unit in which the accommodating groove is located in an extending direction from a distal end of the gingival groove surface to a mesial end of the gingival groove surface.

20. The invisible orthodontic device combination of claim 18, wherein the first retention area is at an angle ranging from 45° to 90° with a vertical surface of a long axis of a tooth on which the attachment is located in an extending direction from a gingiva end of the first retention area to an occlusion end of the first retention area; and the third retention area is at an angle ranging from 0° to 30° with the vertical surface of the long axis of the tooth on which the attachment is located in an extending direction from a distal end of the third retention area to a mesial end of the third retention area.

21. The invisible orthodontic device combination of claim 17, wherein the shell-shaped orthodontic appliance comprises a labial-buccal shell and a lingual shell, and the accommodating groove is disposed in the labial-buccal shell and located in any one or more of shell units of the shell-shaped orthodontic appliance that correspond to molars and premolars.

22. The invisible orthodontic device combination of claim 21, wherein the accommodating groove is located in a shell unit of the shell-shaped orthodontic appliance that corresponds to a last tooth, and/or located in a shell unit of the shell-shaped orthodontic appliance that corresponds to a second-to-last tooth.

23. A construction method for a retention attachment, wherein the retention attachment comprises a bottom surface for attaching to a tooth, and a gingival retention surface, a corner retention surface, and a distal retention surface sequentially connected along a partial edge of the bottom surface, and the method comprises the following steps:
obtaining a dentition model and a shell-shaped orthodontic appliance model matching the dentition model; and
selecting a mounting position from an attachment mounting selectable area on the dentition model, and constructing the retention attachment based on the mounting position, wherein the constructing the retention attachment based on the mounting position comprises:
removing the shell-shaped orthodontic appliance model worn on the dentition model from the dentition model, and obtaining a moving track of a reference position on the shell-shaped orthodontic appliance model that corresponds to the mounting position; and
establishing a tangent line of a key position or a direct connection line between two key positions in the moving track, and constructing the retention attachment satisfying the following rules:
a rule 1: the bottom surface fits the attachment mounting selectable area; and
a rule 2: an intersection line of the gingival retention surface and the bottom surface is a first straight line, an intersection line of the gingival retention surface and the corner retention surface comprises a highest point in a normal direction of the bottom surface, and a plane defined by the first straight line and the highest point is at an angle ranging from 60° to 90° with the tangent line or the direct connection line; or an intersection line of the gingival retention surface and the corner retention surface is a second straight line, an intersection line of the gingival retention surface and the bottom surface comprises a farthest point away from the corner retention surface, and a plane defined by the second straight line and the farthest point is at an angle ranging from 60° to 90° with the tangent line or the direct connection line.

24. The construction method for a retention attachment of claim 23, wherein the step of “selecting a mounting position from an attachment mounting selectable area on the dentition model, and constructing the retention attachment based on the mounting position” further comprises:
using the tangent line or the direct connection line in the step of “establishing a tangent line of a key position or a direct connection line between two key positions in the moving track” as a first auxiliary line, and further establishing a second auxiliary line different from the first auxiliary line, wherein the second auxiliary line is a tangent line of a key position or a direct connection line between two key positions in the moving track; and
the retention attachment further satisfies a rule 4: a plane defined by two endpoints of an intersection line of the corner retention surface and the bottom surface and the highest point is at an angle ranging from 60° to 90° with the second auxiliary line.

25. The construction method for a retention attachment of claim 24, wherein the corner retention surface is convex-arc-shaped on a cross-section perpendicular to the normal direction of the bottom surface.

26. The construction method for a retention attachment of claim 24, wherein the key position is selected from a start position, an end position that is defined by an intersection point of a boundary of a normal projection space of the attachment mounting selectable area and the moving track, and transitional positions located between the start position and the end position.

27. The construction method for a retention attachment of claim 26, wherein the first auxiliary line is set as a tangent line of the start position, and the second auxiliary line is set as a direct connection line between the start position and the end position.

28. The construction method for a retention attachment of claim 25, wherein any one of the gingival retention surface, the corner retention surface, and the distal retention surface is set as: extending away from the bottom surface along a straight line at an angle ranging from 60° to 120° with the bottom surface.

29. The construction method for a retention attachment of claim 28, wherein each of the gingival retention surface and the distal retention surface is set as a plane or a curved surface, and the corner retention surface is set as a cylindrical arc surface.

30. The construction method for a retention attachment of claim 24, wherein the intersection line of the gingival retention surface and the bottom surface comprises the farthest point away from the corner retention surface and a closest point intersecting with the corner retention surface;
an intersection line of the distal retention surface and the bottom surface comprises an extremely far point away from the corner retention surface and an extremely close point intersecting with the corner retention surface; and
the step of “establishing a tangent line of a key position or a direct connection line between two key positions in the moving track, and constructing the retention attachment satisfying the following rules” further comprises a rule 3: on a projection surface in the normal direction of the bottom surface, a direct connection line from the closest point to the farthest point is at an angle ranging from 60° to 120° with a direct connection line from the extremely close point to the extremely far point.

31. The construction method for a retention attachment of claim 30, wherein the gingival retention surface is set as: extending away from the bottom surface in a concave curved shape from the intersection line of the gingival retention surface and the bottom surface, and a plane defined by two endpoints of the intersection line of the gingival retention surface and the bottom surface and the highest point is an angle ranging from 60° to 120° with the bottom surface;
and/or the corner retention surface is set as: extending away from the bottom surface in a concave curved shape from the intersection line of the corner retention surface and the bottom surface, and a plane defined by the extremely close point, the closest point, and the highest point is an angle ranging from 60° to 120° with the bottom surface;
and/or the distal retention surface is set as: extending away from the bottom surface in a concave curved shape from the intersection line of the distal retention surface and the bottom surface, and a plane defined by two endpoints of the intersection line of the distal retention surface and the bottom surface and a highest endpoint of an intersection line of the distal retention surface and the corner retention surface in the normal direction of the bottom surface is an angle ranging from 60° to 120° with the bottom surface.

32. The construction method for a retention attachment of claim 30, wherein on the projection surface in the normal direction of the bottom surface, a direct connection line between the farthest point and the closest point is at an angle ranging from 60° to 90° with a long axis of a tooth on which the attachment mounting selectable area is located;
and/or on the projection surface in the normal direction of the bottom surface, a direct connection line between the extremely far point and the extremely close point is at an angle ranging from 0° to 45° with the long axis of the tooth on which the attachment mounting selectable area is located.

33. The construction method for a retention attachment of claim 23, wherein an upper edge of any one of the gingival retention surface, the corner retention surface, and the distal retention surface defines a maximum height of the retention attachment in the normal direction of the bottom surface.

34. The construction method for a retention attachment of claim 23, wherein in the step of “obtaining a moving track of a reference position on the shell-shaped orthodontic appliance model that corresponds to the mounting position”, N coordinates of the reference position under a space coordinate system are sequentially recorded, the N coordinates are fit into one curved line in sequence, and the curved line forms the moving track, wherein N≥2, and the N coordinates comprise a start coordinate of the reference position corresponding to a case that the shell-shaped orthodontic appliance model is worn on the dentition model.

35. The construction method for a retention attachment of claim 23, wherein the attachment mounting selectable area is located on a labial-buccal surface of the dentition model; and
in the step of “removing the shell-shaped orthodontic appliance model worn on the dentition model from the dentition model”, a lingual side of the shell-shaped orthodontic appliance model is used as an acting area of an actuating force, and the shell-shaped orthodontic appliance model worn on the dentition model is removed from the dentition model with the actuating force,
wherein the actuating force points to an occlusion end along a long axis; or the actuating force comprises a component pointing to an occlusion end along a long axis and a component pointing to the labial-buccal surface perpendicular to the long axis.

36. The construction method for a retention attachment of claim 35, wherein in the step of “removing the shell-shaped orthodontic appliance model worn on the dentition model from the dentition model”, a lingual gingiva edge midpoint of a last molar shell unit of the shell-shaped orthodontic appliance model is used as the acting area of the actuating force.

37. The construction method for a retention attachment of claim 23, wherein the attachment mounting selectable area comprises two or more to-be-selected mounting positions, and in the construction method, all the mounting positions are traversed, to sequentially perform the following on each mounting position: the step of “selecting a mounting position from an attachment mounting selectable area on the dentition model, and constructing the retention attachment based on the mounting position”; and evaluating a retention force of the constructed retention attachment; and
the construction method further comprises a step of: determining a final retention attachment and a mounting position corresponding to the final retention attachment among all constructed retention attachments according to a priority selection principle in which the retention force is maximum.

38. The construction method for a retention attachment of claim 37, wherein a plurality of nodes distributed in a row-column matrix are planned in the attachment mounting selectable area, and all or part of the nodes are used as the to-be-selected mounting positions.

39. The construction method for a retention attachment of claim 37, wherein the “two or more to-be-selected mounting positions” comprise two or more of an internal center point, a mesial edge center point, a mesial edge occlusion endpoint, a mesial edge gingiva endpoint, a distal edge center point, a distal edge occlusion endpoint, a distal edge gingiva endpoint, an occlusion edge center point, and a gingiva edge center point of the attachment mounting selectable area.

40. The construction method for a retention attachment of claim 37, wherein the step of “evaluating a retention force of the constructed retention attachment” comprises:
adding the constructed retention attachment to the dentition model to serve as a second dentition model, and obtaining a second shell-shaped orthodontic appliance model matching the second dentition model; and
obtaining an actuating force of removing the second shell-shaped orthodontic appliance model worn on the second dentition model from the second dentition model, and using the actuating force as the retention force of the retention attachment.

41. A construction system for a retention attachment, comprising a memory and a processor, wherein the memory stores a computer program runnable on the processor, and when the processor executes the computer program, the steps of the construction method for a retention attachment of claim 23 are implemented.

42. A computer-readable storage medium, storing a computer program, wherein when the computer program is executed by a processor, the steps of the construction method for a retention attachment of claim 23 are implemented.

43. An invisible orthodontic appliance, comprising:
a shell-shaped orthodontic appliance, defining an inner cavity capable of accommodating a dentition and comprising an attachment accommodating groove in communication with the inner cavity; and
a retention attachment, wherein the retention attachment is constructed with the construction method for a retention attachment of claim 23, and comprises a bottom surface for attaching to a tooth on a dentition, and each of the gingival retention surface, the corner retention surface, and the distal retention surface butts against a groove surface of the attachment accommodating groove to prevent the orthodontic appliance from separating from the dentition.

44. The invisible orthodontic appliance of claim 43, wherein the orthodontic appliance comprises a labial-buccal shell and a lingual shell, and the attachment accommodating groove is disposed in the labial-buccal shell and located in any one or more of shell units of the orthodontic appliance that correspond to molars and premolars.

45. The invisible orthodontic appliance of claim 44, wherein the attachment accommodating groove is located in a shell unit of the orthodontic appliance that corresponds to a last molar, and/or located in a shell unit of the orthodontic appliance that corresponds to a second-to-last tooth.
